(19) United States
(12) Patent Application Publication
(10) Pub. No.: US 2025/0377151 A1
(43) Pub. Date: Dec. 11, 2025

(54) REFRIGERATOR

(71) Applicant: SAMSUNG ELECTRONICS CO., LTD, Suwon-si (KR)

(72) Inventors: Seulchan CHU, Suwon-si (KR); Hyejeong Oh, Suwon-si (KR); Myounghun Kim, Suwon-si (KR); Jisang Ryu, Suwon-si (KR); Seungwon Woo, Suwon-si (KR); Jooyong Lee, Suwon-si (KR)

(73) Assignee: SAMSUNG ELECTRONICS CO., LTD, Suwon-si (KR)

(21) Appl. No.: 19/204,832

(22) Filed: May 12, 2025

Related U.S. Application Data
(63) Continuation of application No. PCT/KR2025/006087, filed on May 7, 2025.

(30) Foreign Application Priority Data
Jun. 10, 2024 (KR) 10-2024-0075294

(51) Int. Cl. F25D 21/14; F25D 11/02

(52) U.S. Cl. CPC F25D 21/14; F25D 11/02

(57) ABSTRACT

A refrigerator may include an evaporator; a drain pipe to guide the water from a surface of the evaporator, and a drain cap to discharge the water guided by the drain pipe, the drain cap including: a cap body connectable to the drain pipe, and having formed therein a drain flow path along which the water is flowable, and including a hole through which the drain flow path passes, a first magnet configured to be fixed to the cap body, and a water valve movable relative to the cap body to open and close the hole, and including a second magnet, wherein the drain cap is configured so that, with the cap body connected to the drain pipe, the water valve is movable to: close the hole so the water is blocked from passing through the hole, and open the hole so the water may pass through the hole.

### CROSS-REFERENCE TO RELATED APPLICATIONS

This is a continuation application, under 35 U.S.C. § 111 (a), of International Application No. PCT/KR2025/006087, filed May 7, 2025, which claims priority under 35 U.S.C. § 119 to Korean Patent Application No. 10-2024-0075294, filed Jun. 10, 2024, in the Korean Intellectual Property Office, the disclosures of which are incorporated herein in their entireties by reference.

### TECHNICAL FIELD

The present disclosure relates to a refrigerator.

### BACKGROUND ART

A refrigerator is an apparatus including a main body having a storage compartment and a cold air supply system for supplying cold air to the storage compartment, thereby keeping food fresh. The storage compartment includes a refrigerating chamber for storing food in a refrigerated state by maintaining a temperature at about 0 to 5 degrees Celsius, and a freezing chamber for storing food in a frozen state by maintaining a temperature at about 0 to minus 30 degrees Celsius. Generally, the storage compartment is formed to have an open front for putting in and taking out food.

A refrigerator repeats a cooling cycle in which a refrigerant is compressed, condensed, expanded, and evaporated using a compressor, a condenser, an expander, and an evaporator. The evaporator may be configured to absorb ambient heat while low-pressure and low-temperature refrigerant evaporates to exchange heat between air in a storage compartment and the refrigerant. A freezing chamber and a refrigerating chamber may be cooled by a single evaporator provided on the freezing chamber side, or the freezing chamber and the refrigerating chamber may be cooled independently by respective evaporators.

Water vapor introduced into a space at room temperature outside a storage compartment or water vapor evaporating from moisture contained in food inside the storage compartment may form frost on a low temperature surface of an evaporator due to a temperature difference. The frost formed on the surface of the evaporator may reduce heat exchange efficiency, thereby decreasing cooling efficiency of a refrigerator and increasing power consumption. Therefore, a refrigerator may include a defroster to remove frost on an evaporator surface. Defrosted water generated during a defrosting operation by the defroster may be discharged into a machine room through a drain pipe.

### DISCLOSURE

### Technical Problem

The present disclosure is directed to providing a refrigerator having an improved structure to open and close a drain flow path through which defrosted water is drained.

The present disclosure is directed to providing a refrigerator having an improved structure such that a drain flow path is opened when defrosted water is drained and closed when defrosted water is not drained.

The present disclosure is directed to providing a refrigerator having an improved structure to prevent air in a machine room from being introduced into a drain cap when defrosted water is not drained.

The present disclosure is directed to providing a refrigerator with an improved structure such that air in a machine room may be introduced into a storage compartment through a drain cap when a door is opened.

Technical tasks to be achieved in the present disclosure are not limited to the technical tasks mentioned above, and other technical tasks not mentioned will be clearly understood by those skilled in the art from the description below.

### Technical Solution

In accordance with the present disclosure a refrigerator may include: an evaporator; a drain pipe configured to guide water from a surface of the evaporator; and a drain cap configured to discharge the water guided by the drain pipe. The drain cap may include: a cap body connectable to the drain pipe, the cap body having formed therein a drain flow path along which the water is flowable, and including a valve hole through which the drain flow path passes, a first magnet configured to be fixed to the cap body, and a water valve movable relative to the cap body to open and close the valve hole, and including a second magnet. The drain cap may be configured so that, with the cap body connected to the drain pipe, the water valve is movable between: a closed position where the water valve is moved by a magnetic force between the first magnet and the second magnet to close the valve hole so that the water is blocked from passing through the valve hole by the water valve, and an open position where the water valve is moved away from the valve hole by the water overcoming the magnetic force between the first magnet and the second magnet to open the valve hole so that a flow of the water passes through the valve hole and is discharged from the drain cap.

The second magnet may be above the first magnet, and the water valve may be configured to move to the closed position by being ascended by a repulsive force between the first magnet and the second magnet.

The water valve may be configured to be movable between an ascended position in which the water valve may be in the closed position and a descended position in which the water valve may be in the open position and may be spaced apart from the valve hole.

The water valve may be movable below the valve hole.

A width of the valve hole may be smaller than a width of the water valve.

The cap body may include: an inlet configured to allow the water from the drain pipe to be introduced into the cap body, and an outlet configured to allow the water, introduced into the cap body by the inlet, to be discharged from the cap body, and the valve hole may be between the inlet and the outlet.

The drain cap may further include a magnet support configured to fix the first magnet to the cap body.

The magnet support may be configured to guide a movement of the water valve between the closed position and the open position.

The refrigerator may further include: a cooling chamber; and a machine room, wherein the evaporator may be in the cooling chamber, a condenser and a compressor may be in the machine room, the drain cap may be configured so that, with the cap body connected to the drain pipe, the water may be flowable along the drain flow path into the machine room, and an air flow path may be formed inside the cap body and configured so that, with the cap body connected to the drain pipe, air may be flowable from the machine room toward the cooling chamber along the air flow path.

The cap body may include a partition that partitions, in a radial direction of the cap body, a portion of the drain flow path from a portion of the air flow path.

The portion of the drain flow path may be inside the partition, and the portion of the air flow path may be outside the partition.

The drain cap may further include an air valve inside the cap body, and the drain cap may be configured so that, with the cap body connected to the drain pipe, the air valve may be movable relative to the cap body to: close the air flow path, and open the air flow path.

The air valve may be configured to: move to a descended position to close the air flow path by a self-weight of the air valve, and move to an ascended position to open the air flow path by an air pressure difference between the cooling chamber and the machine room.

The water valve may be below the air valve.

The second magnet may be located below the first magnet, and the water valve may be configured to close the valve hole by the water valve being ascended by an attractive force between the first magnet and the second magnet.

A refrigerator according to an embodiment of the present disclosure may include a cooling chamber in which an evaporator is disposed, a machine room in which a condenser and a compressor are disposed, and a drain cap configured to discharge defrosted water condensed inside the cooling chamber into the machine room. The drain cap may include a cap body having a drain flow path formed therein to drain defrosted water and including a valve hole through which the drain flow path passes, a first magnet configured to be fixed to the cap body, and a water valve configured to be movable relative to the cap body and including a second magnet. The water valve may be configured to limit drainage of defrosted water flowing along the drain flow path by closing the valve hole when ascended by a magnetic force between the first magnet and the second magnet. The water valve may be configured to allow defrosted water flowing along the drain flow path to be drained by opening the valve hole when descended by the defrosted water flowing along the drain flow path.

A refrigerator according to an embodiment of the present disclosure may include an evaporator, a drain pipe configured to guide defrosted water from the evaporator, and a drain cap configured to be connected with the drain pipe and including a drain flow path provided to discharge defrosted water guided by the drain pipe. The drain cap may include a first magnet and a second magnet, and may include a water valve configured to be moveable between an ascended position, in which defrosted water is limited from being drained along the drain flow path by being ascended by a magnetic force between the first magnet and the second magnet, and a descended position, in which defrosted water is allowed to be drained along the drain flow path by being descended from the ascended position.

### DESCRIPTION OF DRAWINGS

FIG. 1 is a perspective view of a refrigerator according to an embodiment of the present disclosure.

FIG. 2 is a view illustrating some components disposed in a cooling chamber and machine room of the refrigerator according to an embodiment of the present disclosure.

FIG. 3 is an exploded view illustrating a discharge plug and components of a drain cap of the refrigerator according to an embodiment of the present disclosure.

FIG. 4 is a cross-sectional perspective view illustrating that the discharge plug and drain cap of FIG. 3 are cut away in an assembled state.

FIG. 5 is a cross-sectional view illustrating that the discharge plug and drain cap of FIG. 3 are cut away in the assembled state.

FIG. 6 is a cross-sectional view illustrating that defrosted water is being drained in the state in which the discharge plug and drain cap of FIG. 3 are assembled.

FIG. 7 is a cross-sectional view illustrating that air is being introduced from the machine room in the state in which the discharge plug and drain cap of FIG. 3 are assembled.

FIG. 8 is a view illustrating that a cap body and magnet support of the drain cap of the refrigerator according to an embodiment of the present disclosure are coupled.

FIG. 9 is an exploded view illustrating the discharge plug and components of a drain cap of the refrigerator according to an embodiment of the present disclosure.

FIG. 10 is a cross-sectional perspective view illustrating that the discharge plug and drain cap of FIG. 9 are cut away in an assembled state.

FIG. 11 is a cross-sectional view illustrating that the discharge plug and drain cap of FIG. 9 are cut away in the assembled state.

FIG. 12 is a cross-sectional view illustrating that defrosted water is being drained in the state in which the discharge plug and drain cap of FIG. 9 are assembled.

FIG. 13 is a cross-sectional view illustrating that air is being introduced from the machine room in the state in which the discharge plug and drain cap of FIG. 9 are assembled.

FIG. 14 is an exploded view illustrating components of a drain cap of the refrigerator according to an embodiment of the present disclosure.

FIG. 15 is a cross-sectional perspective view illustrating that the drain cap of FIG. 14 is cut away in an assembled state.

FIG. 16 is a cross-sectional view illustrating that the drain cap of FIG. 14 is cut away in the assembled state.

FIG. 17 is a cross-sectional view illustrating that defrosted water is being drained in the state in which the drain cap of FIG. 14 is assembled.

FIG. 18 is a cross-sectional view illustrating that air is being introduced from the machine room in the state in which the drain cap of FIG. 14 is assembled.

FIG. 19 is an exploded view illustrating components of a drain cap of the refrigerator according to an embodiment of the present disclosure.

FIG. 20 is a cross-sectional perspective view illustrating that the drain cap of FIG. 19 is cut away in an assembled state.

FIG. 21 is a cross-sectional view illustrating that the drain cap of FIG. 19 is cut away in the assembled state.

FIG. 22 is a cross-sectional view illustrating that defrosted water is being drained in the state in which the drain cap of FIG. 19 is assembled.

FIG. 23 is a cross-sectional view illustrating that air is being introduced from the machine room in the state in which the drain cap of FIG. 19 is assembled.

FIG. 24 is an exploded view illustrating components of a drain cap of the refrigerator according to an embodiment of the present disclosure.

FIG. 25 is a cross-sectional perspective view illustrating that the drain cap of FIG. 24 is cut away in an assembled state.

FIG. 26 is a cross-sectional view illustrating that the drain cap of FIG. 24 is cut away in the assembled state.

FIG. 27 is a cross-sectional view illustrating that defrosted water is being drained in the state in which the drain cap of FIG. 24 is assembled.

FIG. 28 is a cross-sectional view illustrating that air is being introduced from the machine room in the state in which the drain cap of FIG. 24 is assembled.

FIG. 29 is an exploded view illustrating the discharge plug and components of a drain cap of the refrigerator according to an embodiment of the present disclosure.

FIG. 30 is a cross-sectional perspective view illustrating that the discharge plug and drain cap of FIG. 29 are cut away in an assembled state.

FIG. 31 is a cross-sectional view illustrating that the discharge plug and drain cap of FIG. 29 are cut away in the assembled state.

FIG. 32 is a cross-sectional view illustrating that defrosted water is being drained in the state in which the discharge plug and drain cap of FIG. 29 are assembled.

FIG. 33 is a cross-sectional view illustrating that air is being introduced from the machine room in the state in which the discharge plug and drain cap of FIG. 29 are assembled.

### MODE OF THE DISCLOSURE

Various embodiments of the present disclosure and the terms used therein are not intended to limit the technical features described in the present disclosure to specific embodiments, and should be understood to include various modifications, equivalents, or substitutes of the embodiments.

In connection with the description of the drawings, like reference numbers may be used for like or related components.

The singular form of a noun corresponding to an item may include one item or a plurality of items, unless the relevant context clearly dictates otherwise.

In the present disclosure, each of phrases such as “A or B,” “at least one of A and B,” “at least one of A or B,” “A, B or C,” “at least one of A, B and C,” and “at least one of A, B, or C” may include any one of the items listed together in the corresponding one of the phrases, or all possible combinations thereof.

The term “and/or” includes any combination of a plurality of related components or any one of a plurality of related components.

Terms such as “first,” “second,” “primary,” and “secondary” may simply be used to distinguish a given component from other corresponding components, and do not limit the corresponding components in any other aspect (e.g., importance or order).

In the present disclosure, the terms “front surface,” “rear surface,” “upper surface,” “lower surface,” “side surface,” “left side,” “right side,” “upper portion,” and “lower portion” used in the following description are defined with reference to the drawings, and the shape and position of each component are not limited by these terms.

The terms “comprises” and “has” are intended to indicate that there are features, numbers, steps, operations, components, parts, or combinations thereof described in the present disclosure, and do not exclude the presence or addition of one or more other features, numbers, steps, operations, components, parts, or combinations thereof.

When any component is referred to as being “connected”, “coupled”, “supported” or “in contact” with another component, this includes a case in which the components are indirectly connected, coupled, supported, or in contact with each other through a third component as well as directly connected, coupled, supported, or in contact with each other.

When any component is referred to as being located “on” or “above” another component, this includes not only a case in which any component is in contact with another component but also a case in which another component is present between the two components.

A refrigerator according to one embodiment may include a main body.

The “main body” may include an inner case, an outer case disposed on the outside of the inner case, and a heat insulator provided between the inner case and the outer case.

The “inner case” may include at least one of a case, a plate, a panel and a liner forming a storage compartment. The inner case may be formed as a single body or may be formed by assembling a plurality of plates. The “outer case” may form an outer appearance of the main body and may be coupled to the outside of the inner case so that the heat insulator is disposed between the inner case and the outer case.

The “heat insulator” may insulate the inside and outside of the storage compartment so that a temperature inside the storage compartment may be maintained at a set appropriate temperature without being affected by an external environment of the storage compartment. According to one embodiment, the heat insulator may include a foam heat insulator such as polyurethane foam. A foam heat insulator may be formed by injecting and foaming urethane foam mixed with polyurethane and foaming agent between the inner case and the outer case.

According to one embodiment, the heat insulator may further include a vacuum heat insulator in addition to the foam heat insulator, or may be configured as only the vacuum heat insulator instead of the foam heat insulator. The vacuum heat insulator may include a core material and an outer shell material that accommodates the core material and seals the inside thereof with a vacuum or a pressure close to vacuum. However, the heat insulator is not limited to the foam heat insulator or vacuum heat insulator described above and may include various materials that may be used for heat insulation.

The “storage compartment” may include a space defined by the inner case. The storage compartment may further include an inner case defining a space corresponding to the storage compartment. The storage compartment may store various items such as food, medicine, and cosmetics, and may be formed such that at least one side thereof is open to allow items to be put in and to be taken out.

The refrigerator may include one or more storage compartments. When two or more storage compartments are formed in the refrigerator, the respective storage compartments may have different uses and may be maintained at different temperatures. To this end, the respective storage compartments may be partitioned from each other by partitions including the heat insulators.

The storage compartment may be provided to be maintained at an appropriate temperature range depending on the use, and may include a “refrigerating chamber,” a “freezing chamber,” or a “variable temperature chamber” depending on the use and/or temperature range. The refrigerating chamber may be maintained at an appropriate temperature for storing items in a refrigerated state, and the freezing chamber may be maintained at an appropriate temperature for storing items in a frozen state. “Refrigerating” may refer to cooling items to the point where the items are not frozen, and as an example, the refrigerating chamber may be maintained in a temperature ranging from zero degree Celsius to seven degrees Celsius. “Freezing” may refer to cooling items such that the items are freezing or maintained in a frozen state, as an example, the freezing chamber may be maintained at a temperature ranging from minus twenty degrees Celsius to minus one degree Celsius. The variable temperature chamber may be used as any one of the refrigerating chamber and the freezing chamber, depending on a selection of a user or regardless of the selection of the user.

In addition to names such as “refrigerating chamber,” “freezing chamber,” and “variable temperature chamber,” the storage compartment may be referred to as various names such as “vegetable chamber,” “fresh chamber,” “cooling chamber,” and “ice making chamber,” terms such as “refrigerating chamber,” “freezing chamber,” and “variable temperature chamber” used below should be understood to encompass storage compartments with corresponding uses and temperature ranges, respectively.

According to one embodiment, the refrigerator may include at least one door configured to open and close the one open side of the storage compartment. The doors may each be provided to open and close the one or more storage compartments, or the one door may be provided to open and close a plurality of the storage compartments. The door may be rotatably or slidingly installed on a front side of the main body.

The “door” may be configured to seal the storage compartment when closed. Like the main body, the door may include the heat insulator to insulate the storage compartment when closed.

According to one embodiment, the door may include a door outer plate forming a front surface of the door, a door inner plate forming a rear surface of the door and facing the storage compartment, an upper cap, a lower cap, and a door heat insulator provided inside the upper and lower caps.

Edges of the door inner plate may be provided with a gasket sealing the storage compartment by coming into close contact with the front side of the main body when the door is closed. The door inner plate may include a dyke protruding rearward so that a door basket for storing items is mounted.

According to one embodiment, the door may include a door body, and a front panel detachably coupled to a front side of the door body and forming the front surface of the door. The door body may include the door outer plate forming a front surface of the door body, the door inner plate forming a rear surface of the door body and facing the storage compartment, the upper cap, the lower cap, and the door heat insulator provided inside the upper and lower caps.

Refrigerators may be classified into a French door type, a side-by-side type, a bottom mounted freezer (BMF) type, a top mounted freezer (TMF) type, and a one-door refrigerator type depending on the arrangement of doors and storage compartments.

According to one embodiment, the refrigerator may include a cold air supply system configured to supply cold air to the storage compartment.

The “cold air supply device” may include a machine, mechanism, electronic device, and/or a system combining them capable of generating cold air and guiding the cold air to cool the storage compartment.

According to one embodiment, the cold air supply system may generate cold air through a refrigeration cycle including compression, condensation, expansion, and evaporation processes of a refrigerant. To this end, the cold air supply system may include a refrigeration cycle device having a compressor, a condenser, an expansion device, and an evaporator capable of driving the refrigeration cycle. According to one embodiment, the cold air supply system may include a semiconductor such as a thermoelectric element. The thermoelectric element may cool the storage compartment by generating heat and cooling through the Peltier effect.

According to one embodiment, the refrigerator may include a machine room in which at least some components belonging to the cold air supply system are disposed.

The “machine room” may be provided to be partitioned and insulated from the storage compartment in order to prevent heat generated from the components disposed in the machine room from being transferred to the storage compartment. The inside of the machine room may be configured to communicate with the outside of the main body to dissipate heat from the components disposed inside the machine room.

According to one embodiment, the refrigerator may include a dispenser provided on the door to provide water and/or ice. The dispenser may be provided on the door such that the user may access the door without opening the door.

According to one embodiment, the refrigerator may include an ice making device provided to produce ice. The ice making device may include an ice making tray provided to store water, an ice moving device provided to separate the ice from the ice making tray, and an ice bucket provided to store the ice produced in the ice making tray.

According to one embodiment, the refrigerator may include a controller configured to control the refrigerator.

The “controller” may include memory provided to store or remember programs and/or data for controlling the refrigerator, and a processor provided to output a control signal for controlling the cold air supply system and the like according to the programs and/or data stored in the memory.

The memory stores or records a variety of information, data, commands, programs, and the like required for operations of the refrigerator. The memory may remember temporary data generated while generating control signals for controlling components included in the refrigerator. The memory may include at least one of volatile memory and non-volatile memory, or a combination thereof.

The processor controls the overall operation of the refrigerator. The processor may control the components of the refrigerator by executing the programs stored in the memory. The processor may include a separate NPU to perform operations of an artificial intelligence model. The processor may also include a central processor, a graphics processor (GPU), and the like. The processor may generate a control signal for controlling an operation of the cold air supply system. For example, the processor may receive temperature information of the storage compartment from a temperature sensor, and generate a cooling control signal for controlling the operation of the cold air supply system based on the temperature information of the storage compartment.

Additionally, the processor may process user input of a user interface according to the programs and/or data memorized/stored in the memory and control an operation of the user interface. The user interface may be provided using an input interface and an output interface. The processor may receive the user input from the user interface. The processor may also transmit a display control signal and image data for displaying an image on the user interface to the user interface in response to the user input.

The processor and the memory may be provided integrally or may be provided separately. The processor may include one or more processors. For example, the processor may include a main processor and at least one sub-processor. The memory may include one or more memories.

According to one embodiment, the refrigerator may include a processor and a memory to control all the components included in the refrigerator, and may include a plurality of processors and a plurality of memories to individually control the components of the refrigerator. For example, the refrigerator may include a processor and memory to control the operation of the cold air supply system depending on output of the temperature sensor. Also, the refrigerator may be separately equipped with a processor and memory to control the operation of the user interface according to user input.

A communication module may communicate with an external device such as a server, a mobile device, and another home appliance through a nearby access point (AP). The access point (AP) may connect a local area network (LAN) to which the refrigerator or a user device is connected to a wide area network (WAN) to which the server is connected. The refrigerator or the user device may be connected to the server via the wide area network (WAN).

The input interface may include a key, a touch screen, a microphone, and the like. The input interface may receive user input and transmit the user input to the processor.

The output interface may include a display, a speaker, and the like. The output interface may output various notifications, messages, a variety of information, and the like generated by the processor.

Hereinafter, embodiments of the present disclosure will be described in detail with reference to the accompanying drawings.

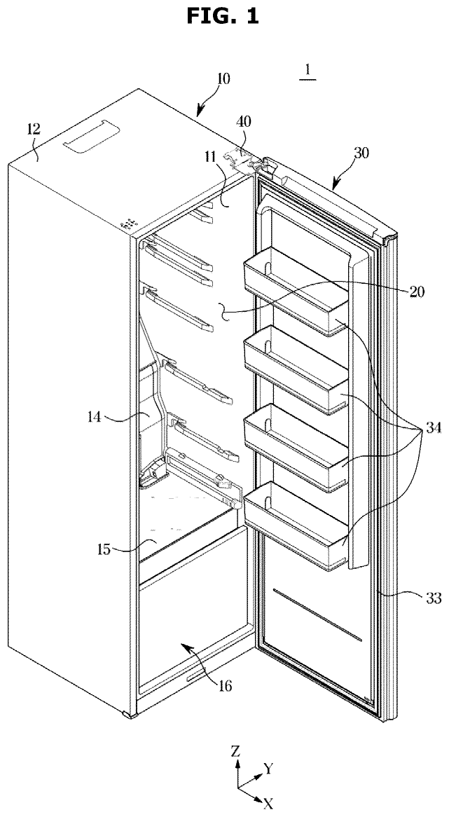

In the description of various embodiments of the present disclosure with reference to FIGS. 1 to 33, the terms “upward,” “downward,” “forward,” “rearward,” “left side,” “right side,” and the like used in the following description are defined with reference to the drawings, and the shape and position of each component are not limited by these terms. For example, the terms “upward” and “downward” below may refer to upward in a Z direction and downward in the Z direction with respect to the drawings, respectively. The terms “forward” and “rearward” in the following description may refer to forward and rearward in an X direction with respect to the drawings, respectively. The terms “left side” and “right side” in the following description may refer to the left side and right side in a Y direction with respect to the drawings, respectively.

FIG. 1 is a perspective view of a refrigerator according to an embodiment of the present disclosure.

Referring to FIG. 1, a refrigerator 1 according to an embodiment of the present disclosure may include a main body 10, a storage compartment 20 provided inside the main body 10, an opening/closing door 30 configured to open and close the storage compartment 20, and a cooling system configured to supply cold air to the storage compartment 20.

The main body 10 may include an inner case 11 forming the storage compartment 20 and an outer case 12 forming an outer appearance of the refrigerator 1.

The outer case 12 may be formed to have a substantially box shape with an open front. The outer case 12 may form an upper surface, a lower surface, left and right surfaces, a rear surface, and the like of the refrigerator 1.

The inner case 11 may have an open front side. The inner case 11 has the storage compartment 20 therein and may be provided inside the outer case 12. An inner wall of the inner case 11 may form an inner wall of the storage compartment 20.

A heat insulator may be provided between the inner case 11 and the outer case 12 to insulate a space between the inner case 11 and the outer case 12. As the heat insulator is foamed between the inner case 11 and the outer case 12, the inner case 11 and the outer case 12 may be coupled together. For example, the heat insulator may include heat insulators made of various materials, such as a urethane foam heat insulator (urethane foam insulation), an EPS heat insulator (expanded polystyrene insulation), and a vacuum heat insulator (vacuum insulation panel).

The storage compartment 20 may be formed inside the main body 10. As an example, the storage compartment may include a refrigerating chamber to store food in a refrigerated state by maintaining a temperature at about 0 to 5 degrees Celsius. As an example, the storage compartment may include a freezing chamber to store food in a frozen state by maintaining a temperature at about 0 to minus 30 degrees Celsius.

Inside the storage compartment 20, shelves on which food may be placed and a storage container in which food may be stored may be provided.

The refrigerator 1 may include a drawer 16 in which food may be stored and provided to be withdrawn from or inserted into the storage compartment 20. The drawer 16 may be provided to be slidably movable relative to the inner case 11.

The refrigerator 1 may include a partition 15 provided to partition the inside of the storage compartment 20 into a plurality of spaces. As an example, the partition 15 may extend in a horizontal direction to partition an inner space of the storage compartment 20 up and down. As an example, the partition 15 may partition the inside of the storage compartment 20 into an outer space of the drawer 16 and an inner space of the drawer 16.

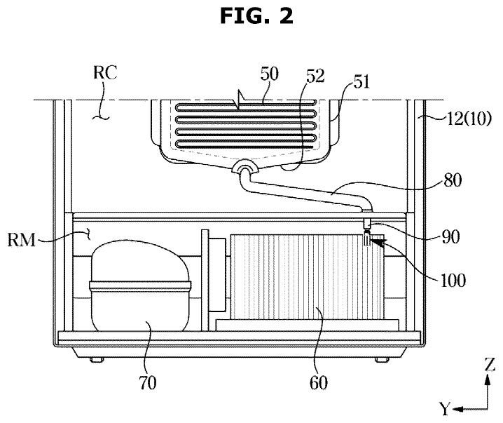

The refrigerator 1 may include a cooling system configured to generate cold air using a cooling cycle and supply the generated cold air to the storage compartment 20. The cooling system may generate cold air using a cooling and circulation cycle in which a refrigerant is compressed, condensed, expanded, and evaporated. As an example, the cooling system may include a compressor 70 (see FIG. 2), a condenser 60 (see FIG. 2), an expansion valve, an evaporator 50 (see FIG. 2), a blowing fan, and the like.

The main body 10 may include a cold air supply duct 14 forming a cold air flow path through which cold air generated by the cooling system flows into the storage compartment 20. The cold air supply duct 14 may be disposed on a rear side of the inner case 11. A cooling chamber RC, which will be described later, may be connected to the storage compartment 20 through a hole formed on the cold air supply duct 14, and cold air generated by the evaporator 50 may be supplied to the storage compartment 20 through the hole formed on the cold air supply duct 14.

The door 30 may be configured to open and close the storage compartment 20. The door 30 may be configured to be rotatable relative to the main body 10. The door 30 may be rotatably coupled to the main body 10 by a hinge 40 connecting the door 30 and the main body 10.

A door gasket 33 may be provided on an inner surface of the door 30 to seal a gap between the door 30 and the main body 10 to prevent cold air from leaking out of the storage compartment 20. The door gasket 33 may be composed of an elastic material such as rubber.

The inner surface of the door 30 may be provided with door shelves 34 on which food may be stored.

Although the one-door type refrigerator 1 according to an embodiment is described above with reference to FIG. 1, the present disclosure is not limited thereto. Unlike that illustrated in FIG. 1, in various embodiments of the present disclosure, the refrigerator may be a type of refrigerator in which a main body is opened and closed by a plurality of doors. For example, in various embodiments of the present disclosure, the refrigerator may include various types of refrigerators, such as a side-by-side type in which a refrigerating chamber and a freezing chamber are arranged left and right, a bottom mounted freezer (BMF) type in which a refrigerating chamber is disposed on an upper side and a freezing chamber is disposed on a lower side, a top mounted freezer (TMF) type in which a freezing chamber is disposed on an upper side and a refrigerating chamber is disposed on a lower side, or a French door type.

The configuration of the refrigerator 1 described above with reference to FIG. 1 is only an example for explaining the refrigerator according to the present disclosure, and the present disclosure is not limited thereto. The refrigerator according to the present disclosure may be provided to include various configurations for performing the function of supplying cold air to a storage compartment for storing food.

FIG. 2 is a view illustrating some components disposed in a cooling chamber and machine room of the refrigerator according to an embodiment of the present disclosure.

Referring to FIG. 2, the refrigerator 1 according to an embodiment of the present disclosure may include the evaporator 50, the condenser 60, and the compressor 70 provided as components of the cooling cycle.

The refrigerator 1 may include the cooling chamber RC formed inside the main body 10. The evaporator 50 may be disposed inside the cooling chamber RC, and thus cold air may be generated in the cooling chamber RC. The blowing fan may be disposed inside the cooling chamber RC, and the blowing fan may flow cold air generated by the evaporator 50 to the storage compartment 20.

As an example, an evaporator housing 51 configured to accommodate the evaporator 50 may be provided inside the cooling chamber RC.

The cooling chamber RC may be disposed at the rear of the storage compartment 20. The cooling chamber RC may be disposed at the rear of the cold air supply duct 14.

The refrigerator 1 may include a machine room RM formed inside the main body 10. The machine room RM may be partitioned from the cooling chamber RC. For example, the machine room RM may be disposed below the cooling chamber RC.

The compressor 70 may be disposed inside the machine room RM. The condenser 60 may be disposed inside the machine room RM.

The cooling chamber RC may be maintained at a relatively low temperature because cold air is generated by the evaporator 50 therein. The machine room RM may be maintained at a relatively high temperature because heat may be generated by the compressor 70 and the condenser 60 therein. Therefore, a heat insulator may be provided between the cooling chamber RC and the machine room RM to insulate the cooling chamber RC and the machine room RM.

As the refrigerator 1 operates, frost may form on a surface of the low-temperature evaporator 50. For example, water vapor introduced from a room temperature space outside the storage compartment 20 or water vapor evaporated from moisture contained in food inside the storage compartment 20 may condense and freeze on the surface of the evaporator 50, which causes frost to form on the surface of the evaporator 50. The frost formed on the evaporator 50 may affect heat exchange performance of the evaporator 50, which may decrease cooling efficiency of the refrigerator 1 and increase power consumption. Accordingly, the refrigerator 1 may include a defroster to remove frost on the surface of the evaporator 50. In detail, the refrigerator 1 may include a defrost heater installed adjacent to the evaporator 50, and the defrost heater may be configured to generate heat at regular intervals to remove frost.

When the frost on the evaporator 50 is melted by the defroster, defrosted water may be generated. The defrosted water flows along the surface of the evaporator 50 and may be drained downward. For example, defrosted water generated in the evaporator 50 may flow downward toward a defrosted water tray 52 provided on a lower side of the evaporator housing 51. The defrosted water tray 52 may be configured to guide defrosted water downward.

The refrigerator 1 may include a drain pipe 80 configured to guide defrosted water from the evaporator 50.

The drain pipe 80 may form a flow path through which defrosted water is drained therein. The drain pipe 80 may include structures of various shapes, such as a pipe and a flexible hose in which a flow path is formed. The drain pipe 80 may include various materials such as plastic, rubber, and metal.

The drain pipe 80 may be configured to guide defrosted water from the evaporator 50 to the machine room RM. For example, the drain pipe 80 may be connected to the defrosted water tray 52 to guide defrosted water collected in the defrosted water tray 52 to the machine room RM. The drain pipe 80 may connect the defrosted water tray 52 and the machine room RM.

At least a portion of the drain pipe 80 may be buried by the heat insulator provided between the cooling chamber RC and the machine room RM.

The refrigerator 1 may include a discharge plug 90 connected with the drain pipe 80. The discharge plug 90 may be connected to the defrosted water tray 52 through the drain pipe 80.

The discharge plug 90 may be coupled to the drain pipe 80. Alternatively, the discharge plug 90 may be formed integrally with the drain pipe 80, and in this case, the discharge plug 90 may be defined as a portion of the drain pipe 80.

The discharge plug 90 may be disposed in the machine room RM. The discharge plug 90 may be connected to one end of the drain pipe 80 on the machine room RM side. Defrosted water guided to the machine room RM along the drain pipe 80 may be connected to the machine room RM through the discharge plug 90.

The discharge plug 90 may be configured to discharge defrosted water introduced from the drain pipe 80 downward. For example, defrosted water may be introduced into the discharge plug 90 from above and may be discharged from the discharge plug 90 downward. As an example, the discharge plug 90 may be disposed in a vertical direction, and defrosted water may be discharged vertically downward along the discharge plug 90. Alternatively, the discharge plug 90 may be disposed to be inclined at a predetermined angle with respect to the vertical direction of the refrigerator 1, and in this case, defrosted water may flow in an inclined direction along the discharge plug 90.

As an example, the discharge plug 90 may have a substantially cylindrical shape forming a hollow portion therein. Defrosted water introduced into the discharge plug 90 from the drain pipe 80 may flow along the hollow portion of the discharge plug 90.

The refrigerator 1 may include a drain cap 100. The drain cap 100 may be connected with the drain pipe 80. In detail, the drain cap 100 may be connected with the drain pipe 80 through the discharge plug 90. The drain cap 100 may be configured to discharge defrosted water guided by the drain pipe 80. The drain cap 100 may be configured to discharge defrosted water from the discharge plug 90.

The drain cap 100 may be disposed in the machine room RM. The drain cap 100 may be configured to discharge defrosted water condensed in the cooling chamber RC to the machine room RM. Defrosted water guided to the machine room RM along the drain pipe 80 may be discharged to the machine room RM by sequentially passing through the discharge plug 90 and the drain cap 100.

The drain cap 100 may be configured to discharge defrosted water downward. For example, defrosted water may be introduced into the drain cap 100 from above and may be discharged from the drain cap 100 downward. As an example, the drain cap 100 may be disposed in the vertical direction, and defrosted water may be discharged vertically downward along the drain cap 100. Alternatively, the drain cap 100 may be disposed to be inclined at a predetermined angle with respect to the vertical direction of the refrigerator 1, and in this case, defrosted water may flow in an inclined direction along the drain cap 100.

The drain cap 100 may be configured to limit air in the machine room RM from being introduced into the cooling chamber RC through the discharge plug 90. The drain cap 100 may selectively open or close a flow path through which air flows from the machine room RM toward the cooling chamber RC to allow or limit the inflow of air from the machine room RM.

A detailed description of the structure of the drain cap 100 will be given later.

As such, when defrosted water generated in the evaporator 50 is discharged to the machine room RM through the drain pipe 80, the discharge plug 90, and the drain cap 100, the discharged defrosted water may be collected in an evaporation tray installed in the machine room RM and then evaporated.

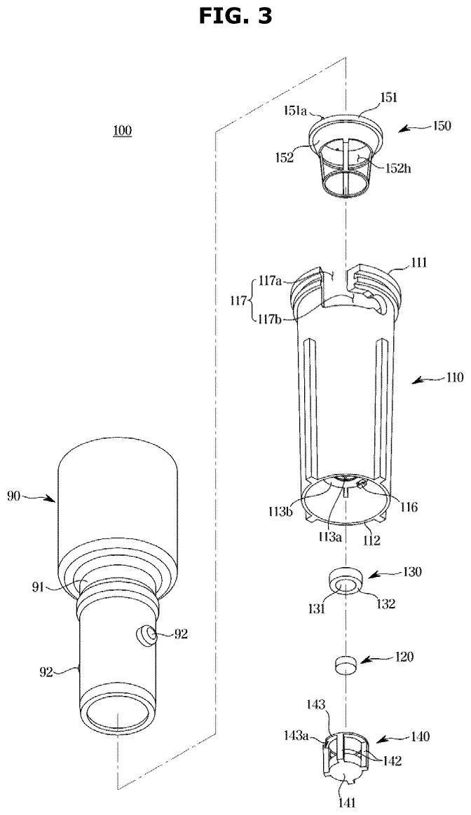

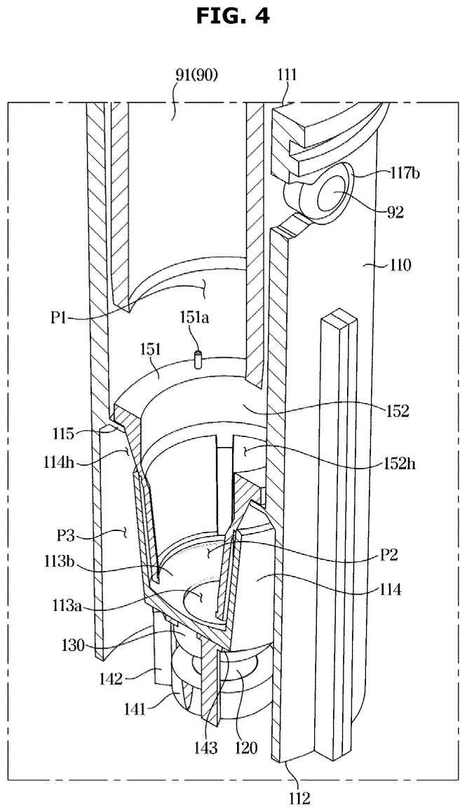

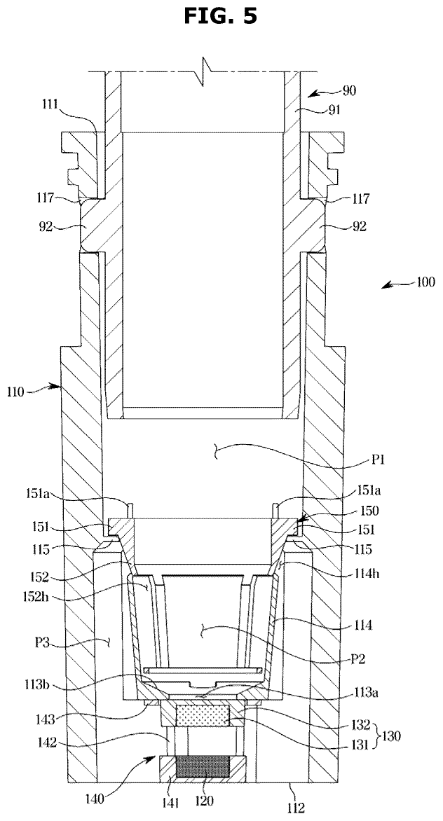

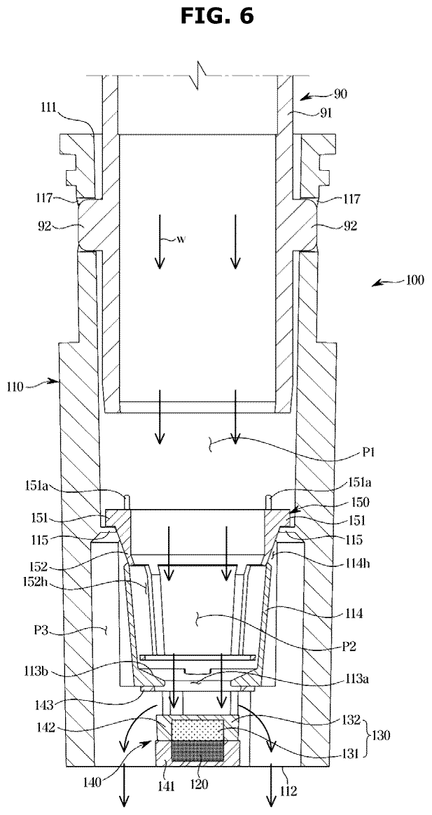

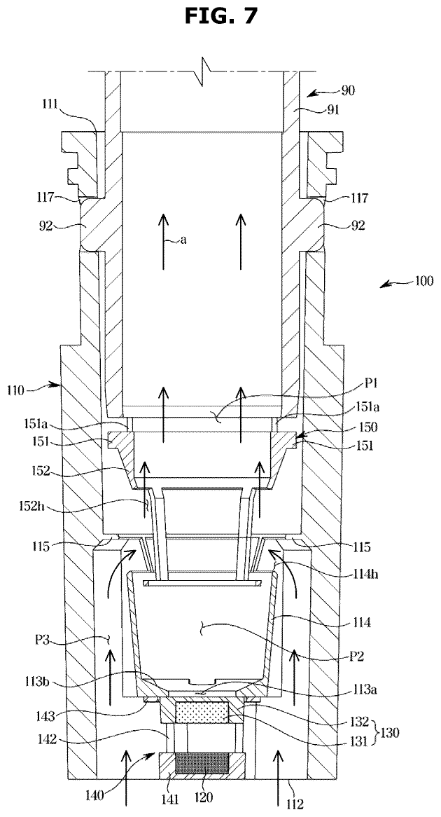

FIG. 3 is an exploded view illustrating a discharge plug and components of a drain cap of the refrigerator according to an embodiment of the present disclosure. FIG. 4 is a cross-sectional perspective view illustrating that the discharge plug and drain cap of FIG. 3 are cut away in an assembled state. FIG. 5 is a cross-sectional view illustrating that the discharge plug and drain cap of FIG. 3 are cut away in the assembled state. FIG. 6 is a cross-sectional view illustrating that defrosted water is being drained in the state in which the discharge plug and drain cap of FIG. 3 are assembled. FIG. 7 is a cross-sectional view illustrating that air is being introduced from the machine room in the state in which the discharge plug and drain cap of FIG. 3 are assembled.

An arrow w in FIG. 6 indicates a drainage direction of defrosted water. An arrow a in FIG. 7 indicates an inflow direction of air.

Referring to FIGS. 3 to 7, the refrigerator 1 according to an embodiment of the present disclosure may include the drain cap 100.

The drain cap 100 may include a cap body 110. The cap body 110 may form a main body of the drain cap 100. The cap body 110 may be connected with the drain pipe 80. The cap body 110 may be connected with the discharge plug 90 and may be connected with the drain pipe 80 through the discharge plug 90.

The cap body 110 may be coupled with the discharge plug 90. The cap body 110 may be coupled to a side adjacent to an outlet of the discharge plug 90. The discharge plug 90 may be coupled to a side adjacent to an inlet 111 of the cap body 110.

For example, the cap body 110 may include a plug coupling portion 117 provided to be coupled to the discharge plug 90. The plug coupling portion 117 may have the shape of a hole penetrating a portion of an outer circumferential surface of the cap body 110. The discharge plug 90 may include a plug body 91 forming a flow path for defrosted water or air to flow therein, and one or more coupling protrusions 92 protruding from an outer circumferential of the plug body 91. The discharge plug 90 and the cap body 110 may be coupled to each other as a coupling protrusion 92 penetrates the plug coupling portion 117 and is caught thereon.

The plug coupling portion 117 may include an insertion portion 117a extending along a longitudinal direction (or an axial direction) of the cap body 110, and a coupling portion 117b extending from the insertion portion 117a along a direction different from the longitudinal direction of the cap body 110 (e.g., a circumferential direction of the cap body 110). As an example, the insertion portion 117a may extend in the longitudinal direction from the inlet 111 of the cap body 110. According to this structure, the coupling protrusion 92 of the discharge plug 90 is first inserted into the insertion portion 117a, and then the cap body 110 is rotated so that the coupling protrusion 92 is caught on the coupling portion 117b, so that the drain cap 100 may be coupled with the discharge plug 90. Conversely, the cap body 110 is rotated so that the coupling protrusion 92 caught on the coupling portion 117b is deviated from the coupling portion 117b, and then the coupling protrusion 92 is deviated from the insertion portion 117a, so that the drain cap 100 may be separated from the discharge plug 90.

With this configuration, the drain cap 100 may be easily coupled with or separated from the discharge plug 90. In addition, according to various embodiments, the drain cap 100 may include various structures to be coupled with the discharge plug 90.

The cap body 110 may include the inlet 111 and an outlet 112. The inlet 111 may be formed on one side of the cap body 110 to allow defrosted water from the drain pipe 80 (or from the discharge plug 90) to be introduced into the cap body 110. The outlet 112 may be formed on the other side of the cap body 110 to allow defrosted water to be discharged from the cap body 110. As an example, the inlet 111 may be positioned above the outlet 112. As an example, the inlet 111 and the outlet 112 may be arranged in the vertical direction parallel to each other, but are not limited thereto, and the positions thereof may vary depending on the shape of a flow path inside the cap body 110.

A flow path may be formed inside the cap body 110. The flow path of the cap body 110 may be formed between the inlet 111 and the outlet 112. The flow path of the cap body 110 may be provided such that defrosted water or air flows therethrough.

In detail, the cap body 110 may include a first flow path P1, a second flow path P2, and a third flow path P3. The first flow path P1 may extend from the inlet 111. For example, the first flow path P1 may extend downward from the inlet 111. The second flow path P2 may extend between the first flow path P1 and the outlet 112. The third flow path P3 may extend between the first flow path P1 and the outlet 112. For example, the second flow path P2 may extend downward from a portion of a lower portion of the first flow path P1, and the third flow path P3 may extend downward from another portion of the lower portion of the first flow path P1. For example, the second flow path P2 and the third flow path P3 may be partitioned from each other in a radial direction of the cap body 110.

The cap body 110 may include a partition 114 configured to partition the second flow path P2 and the third flow path P3. For example, the partition 114 may partition the second flow path P2 and the third flow path P3 in the radial direction. For example, the second flow path P2 may be provided inside the partition 114. For example, the third flow path P3 may be provided outside the partition 114. The partition 114 may be provided inside the cap body 110.

The partition 114 may have a hollow shape of forming a flow path therein. The partition 114 may have a hollow shape of forming the second flow path P2 therein. The partition 114 may have a shape of surrounding the second flow path P2. As an example, the partition 114 may be formed in a substantially hollow cylindrical or truncated cone shape.

A drain flow path may be formed inside the cap body 110 such that defrosted water is drained therethrough. The first flow path P1 may form a portion of the drain flow path (e.g., an upper portion of the drain flow path and an upstream portion of the drain flow path). The second flow path P2 may form another portion of the drain flow path (e.g., a lower portion of the drain flow path and a downstream portion of the drain flow path). Defrosted water introduced into the cap body 110 through the inlet 111 may flow along the first flow path P1 and the second flow path P2 and be discharged from the cap body 110 through the outlet 112.

An air flow path may be formed inside the cap body 110 such that air flows from the machine room RM toward the cooling chamber RC therethrough. The first flow path P1 may form a portion of the air flow path (e.g., an upper portion of the air flow path and a downstream portion of the air flow path). The third flow path P3 may form another portion of the air flow path (e.g., a lower portion of the air flow path and an upstream portion of the air flow path). Air introduced into the cap body 110 through the outlet 112 may flow along the third flow path P3 and the first flow path P1 and be discharged from the cap body 110 through the inlet 111.

Portions of the drain flow path and air flow path may be partitioned from each other by the partition 114. The partition 114 may partition a portion of the drain flow path and a portion of the air flow path in the radial direction. For example, a portion of the drain flow path may be provided inside the partition 114. For example, a portion of the air flow path may be provided outside the partition 114. As such, by the structure in which a portion of the drain flow path and a portion of the air flow path are partitioned from each other, as will be described later, an air valve 150 may open the air flow path even when a water valve 130 closes the drain flow path, and the water valve 130 may open the drain flow path even when the air valve 150 closes the air flow path.

The drain cap 100 may have a structure in which the drain flow path is opened or closed. The drain cap 100 may have a structure in which the drain flow path is opened when defrosted water is drained and the drain flow path is closed when defrosted water is not drained.

The drain cap 100 may include the water valve 130 configured to open or close the drain flow path. The water valve 130 may be disposed inside the cap body 110. The water valve 130 may be disposed on the drain flow path inside the cap body 110. The water valve 130 may be configured to be movable relative to the cap body 110. The water valve 130 may open or close the drain flow path while moving relative to the cap body 110.

The water valve 130 may close the drain flow path in an ascended position (hereinafter referred to as “ascended position”) as illustrated in FIG. 5. The water valve 130 may open the drain flow path at a descended position (hereinafter referred to as “descended position”) from the ascended position as illustrated in FIG. 6. The water valve 130 may be configured to be movable between the ascended position and the descended position.

For example, the cap body 110 may include a valve hole 113a. The valve hole 113a may be provided on the drain flow path. The drain flow path may pass through the valve hole 113a. When the valve hole 113a is opened, defrosted water may be allowed to flow and be drained along the drain flow path, and when the valve hole 113a is closed, defrosted water may be limited from being drained along the drain flow path.

The water valve 130 may be configured to open and close the valve hole 113a. The water valve 130 may be configured to be movable relative to the valve hole 113a. The water valve 130 may close the valve hole 113a in the ascended position. The water valve 130 may close the drain flow path by covering the valve hole 113a in the ascended position. The water valve 130 may block defrosted water from passing through the valve hole 113a by covering the valve hole 113a in the ascended position. The water valve 130 may open the valve hole 113a in the descended position. The water valve 130 may open the drain flow path by being spaced apart from the valve hole 113a in the descended position. The water valve 130 may allow defrosted water to pass through the valve hole 113a by being spaced apart from the valve hole 113a in the descended position.

As an example, the valve hole 113a may be disposed between the inlet 111 and the outlet 112 of the cap body 110.

The cap body 110 may include a valve hole forming portion 113b. The valve hole forming portion 113b may be provided along a circumference of the valve hole 113a. The valve hole 113a may be provided in an inner direction of a circumference of the valve hole forming portion 113b. As an example, the valve hole 113a may be provided substantially at a center of the valve hole forming portion 113b.

The valve hole forming portion 113b may be disposed above the water valve 130. The water valve 130 may be configured to be movable below the valve hole forming portion 113b. In other words, the water valve 130 may be configured to be movable below the valve hole 113a.

The water valve 130 may come into contact with the valve hole forming portion 113b in the ascended position. The water valve 130 that is moving toward the ascended position may stop and cover the valve hole 113a by coming into contact with the valve hole forming portion 113b. As such, the valve hole forming portion 113b may guide the water valve 130 to the ascended position. The valve hole forming portion 113b may limit a movement range of the water valve 130 from above.

In order to prevent the water valve 130 from further being ascended by passing through the valve hole 113a without being limited from being ascended by the valve hole forming portion 113b in the ascended position, a width (e.g., diameter) of the valve hole 113a may be smaller than a width of the water valve 130.

The valve hole 113a may be disposed on the second flow path P2. The second flow path P2 may pass through the valve hole forming portion 113b.

The valve hole 113a may be disposed on an inner side of the partition 114. The valve hole forming portion 113b may be disposed on the inner side of the partition 114. As an example, the valve hole forming portion 113b may be connected to the partition 114. As an example, the valve hole forming portion 113b may be formed integrally with the partition 114.

The valve hole 113a may be provided at a lower portion of the partition 114. The valve hole forming portion 113b may be provided at the lower portion of the partition 114.

The water valve 130 may include a moving magnet 131. The drain cap 100 may include a fixed magnet 120 configured to be fixed to the cap body 110. The water valve 130 may be configured to be movable relative to the cap body 110 using a magnetic force between the moving magnet 131 and the fixed magnet 120. The moving magnet 131 and the fixed magnet 120 may each include a magnetic body having various materials known in the art or various materials to be known in the future.

The fixed magnet and the moving magnet may also be referred to as “first magnet” and “second magnet” respectively.

The water valve 130 may include a water valve body 132 configured to support the moving magnet 131. The moving magnet 131 may be coupled to the water valve body 132. The water valve body 132 may have a shape of encasing a circumference of the moving magnet 131 from the outside. As an example, the water valve body 132 may have a disk shape in which the moving magnet 131 is substantially inserted in a center. As an example, the moving magnet 131 may have at least an exposed lower surface in a state of being coupled to the water valve body 132.

As an example, the water valve body 132 may include a plastic material. As an example, the water valve body 132 may be formed by injection molding of plastic resin. However, the material or manufacturing method of the water valve body 132 is not limited thereto.

Alternatively, the water valve 130 may not include the separate water valve body 132, and the entire water valve 130 may be configured as a magnetic body.

The water valve 130 may be configured such that the moving magnet 131 moves in a direction of becoming away from the fixed magnet 120 or the moving magnet 131 moves in a direction of becoming close to the fixed magnet 120.

The water valve 130 may be ascended by the magnetic force between the fixed magnet 120 and the moving magnet 131. The water valve 130 may be located in the ascended position by the magnetic force between the fixed magnet 120 and the moving magnet 131. The water valve 130 may be configured to close the valve hole 113a and the drain flow path when ascended by the magnetic force between the fixed magnet 120 and the moving magnet 131.

The water valve 130 may be descended by defrosted water flowing along the drain flow path. The water valve 130 may be descended by a hydraulic pressure of defrosted water flowing along the drain flow path, a weight of defrosted water remaining on the water valve 130, etc. The water valve 130 may be located in the descended position by defrosted water flowing along the drain flow path. The water valve 130 may be configured to open the valve hole 113a and the drain flow path when descended by defrosted water flowing along the drain flow path.

In a case in which there is no defrosted water flowing along the drain flow path, the water valve 130 may be ascended or kept in the ascended position relative to the cap body 110 by the magnetic force between the fixed magnet 120 and the moving magnet 131. In a case in which a force, which is the sum of a force of descending the water valve 130 by defrosted water flowing along the drain flow path and a force of gravity acting on the water valve 130, is less than the magnetic force between the fixed magnet 120 and the moving magnet 131, the water valve 130 may be ascended or kept in the ascended position relative to the cap body 110. In a case in which the force, which is the sum of the force of descending the water valve 130 by defrosted water and the force of gravity acting on the water valve 130, is greater than the magnetic force between the fixed magnet 120 and the moving magnet 131, the water valve 130 may be descended or kept in the descended position relative to the cap body 110. By this principle, the water valve 130 may move relative to the cap body 110 and open or close the valve hole 113a and the drain flow path.

For example, the water valve 130 may be configured to close the valve hole 113a and the drain flow path by being ascended by a repulsive force between the moving magnet 131 and the fixed magnet 120. The moving magnet 131 may be disposed above the fixed magnet 120, and an upward magnetic force by the fixed magnet 120 may be applied to the moving magnet 131. Accordingly, the water valve 130 may be ascended or kept in the ascended position relative to the cap body 110.

The drain cap 100 may include a magnet support 140 configured to support the fixed magnet 120. The magnet support 140 may fix the fixed magnet 120 to the cap body 110.

As an example, the magnet support 140 may be disposed on the drain flow path. As an example, the magnet support 140 may be disposed on the second flow path P2.

The magnet support 140 may include a magnet support portion 141 provided to support the fixed magnet 120. The fixed magnet 120 may be coupled to the magnet support portion 141. As an example, the magnet support portion 141 may support the fixed magnet 120 by encasing a circumference of the fixed magnet 120. As an example, the fixed magnet 120 may have at least an exposed upper surface in a state of being coupled to the magnet support portion 141.

The magnet support portion 141 may be disposed below the moving magnet 131. The magnet support portion 141 may be disposed below the water valve 130. The water valve 130 may come into contact with the magnet support portion 141 when reaching the descended position. The magnet support portion 141 may guide the water valve 130 to the descended position. The magnet support portion 141 may limit the movement range of the water valve 130 from below.

As an example, the magnet support portion 141 may be arranged parallel to the valve hole 113a in the vertical direction. As an example, the magnet support portion 141 may be arranged parallel to the valve hole forming portion 113b in the vertical direction. The water valve 130 may be movable between the valve hole 113a, the valve hole forming portion 113b, and the magnet support portion 141.

The magnet support 140 may include a fixed portion 143 provided to be fixed to the cap body 110. The fixed portion 143 may be coupled to the cap body 110. The cap body 110 may include a supporter fixing portion 116, and the fixed portion 143 may be coupled to the supporter fixing portion 116. As an example, the fixed portion 143 may be coupled to the valve hole forming portion 113b, and the supporter fixing portion 116 may be provided on the valve hole forming portion 113b. In detail, the fixed portion 143 may be coupled to a lower side of the valve hole forming portion 113b.

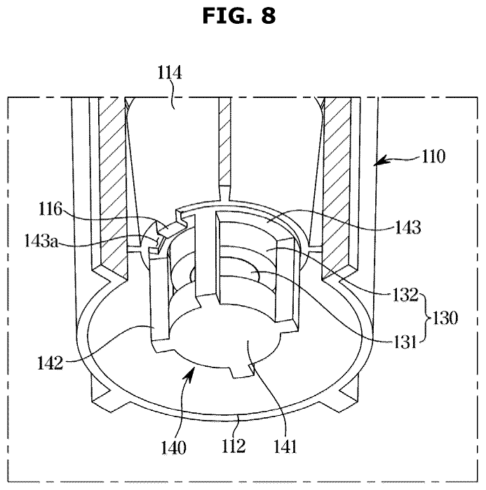

A detailed example of the structure of coupling the fixed portion 143 and the supporter fixing portion 116 will be described later with reference to FIG. 8.

As an example, the fixed portion 143 may include a hole formed such that the second flow path P2 passes therethrough. The fixed portion 143 may have a substantially ring shape with a hole formed in a center thereof. The drain flow path passing through the valve hole 113a may extend toward the outlet 112 through the hole of the fixed portion 143.

The fixed portion 143 may be disposed above the magnet support portion 141. As an example, the fixed portion 143 and the magnet support portion 141 may be arranged parallel to each other in the vertical direction.

The magnet support 140 may include a connecting portion 142 provided to connect the magnet support portion 141 and the fixed portion 143. The connecting portion 142 may support the magnet support portion 141 with respect to the fixed portion 143. The connecting portion 142 may extend substantially downward from the fixed portion 143 toward the magnet support portion 141. As an example, the connecting portion 142 may extend in the vertical direction between the magnet support portion 141 and the fixed portion 143.

The magnet support 140 may be formed such that defrosted water may pass therethrough. The magnet support 140 may be formed such that water may pass therethrough in at least an area between the fixed portion 143 and the magnet support portion 141. For example, the magnet support 140 may include a plurality of the connecting portions 142 spaced apart from each other, and defrosted water may pass between the plurality of connecting portions 142.

The magnet support 140 may be configured to guide a movement of the water valve 130. The magnet support 140 may be configured to guide the movement of the water valve 130 between the ascended position and the descended position. For example, the connecting portion 142 may guide the movement of the water valve 130. The connecting portion 142 may guide the movement of the water valve 130 by being in contact with an outer circumferential surface of the water valve 130. In detail, the plurality of connecting portions 142 may guide the movement of the water valve 130 by being disposed to surround the outer circumferential surface of the water valve 130. The water valve 130 may be movable in a direction parallel to a direction in which the connecting portion 142 extends. In this respect, the connecting portion 142 may also be referred to as the “movement guide 142.”

In various embodiments, the structure of fixing the fixed magnet 120 to the cap body 110 is not limited to that described above, and the fixed magnet 120 may be fixed to the cap body 110 by various structures.

According to an embodiment, the fixed magnet 120 may be directly coupled to the cap body 110, and in this case, the magnet support 140 may be a component of the cap body 110 integrally formed with the cap body 110.

The moving magnet 131 and the fixed magnet 120 may be arranged parallel to each other in the vertical direction. For example, as illustrated in FIGS. 3 to 7, the fixed magnet 120 may be positioned vertically above the moving magnet 131. Alternatively, the fixed magnet 120 and the moving magnet 131 may be arranged not to be parallel to each other in the vertical direction. For example, the fixed magnet 120 is disposed above the moving magnet 131, but may also be disposed to be misaligned in the horizontal direction with respect to the moving magnet 131.

With this structure, the water valve 130 may move relative to the cap body 110 and open or close the valve hole 113a and the drain flow path.

Air pressure may be generated from the cooling chamber RC toward the storage compartment 20 by the blowing fan while the refrigerator 1 is operating, and when the drain flow path is not blocked even though defrosted water is not drained, there is a possibility that air inside the machine room RM may be introduced into the cooling chamber RC or the storage compartment 20 through the drain flow path. When high-temperature and high-humidity air inside the machine room RM is introduced into the cooling chamber RC or the storage compartment 20, there is a possibility that the cooling efficiency of the refrigerator 1 may decrease and the power consumption may increase. In addition, when high-temperature and high-humidity air freezes on the drain cap 100, the discharge plug 90, the drain pipe 80, etc., there is a possibility that defrosted water may not be properly drained. However, in an embodiment of the present disclosure, the water valve 130 opens the drain flow path only when defrosted water flows and is drained along the drain flow path, and closes the drain flow path when defrosted water is not drained, so that when defrosted water is not drained, air in the machine room RM may be prevented from being introduced into the cooling chamber RC or the storage compartment 20 through the drain flow path. Because the inside of the cooling chamber RC is expected to be in a high-pressure state due to a relatively high temperature caused by a defrosting operation even when the drain flow path is opened when defrosted water is drained, it is unlikely that air in the machine room RM would be able to be introduced into the cooling chamber RC through the opened drain flow path.

Although the drain flow path may be closed by the water valve 130, an air flow path may also be formed in the drain cap 100 in addition to the drain flow path. In general cases, as with the drain flow path, the air flow path may need to also be closed to prevent air in the machine room RM from being introduced into the cooling chamber RC through the air flow path.

The air flow path in the drain cap 100 may need to be opened under certain conditions. For example, because the inside of the storage compartment 20 is at a lower temperature than the outside, air pressure outside the refrigerator 1 becomes lower, and due to this air pressure difference, the door 30 may not opened easily even when a user attempts to open the door 30. Therefore, the air flow path may be opened so that the door 30 may be opened more easily as air inside the machine room RM is introduced into the storage compartment 20 through the air path in the drain cap 100 when door 30 is opened.

In order to implement such a function, the drain cap 100 may have a structure in which the air flow path is opened or closed. The drain cap 100 may be configured such that the air flow path is closed when the magnitude of air pressure directing to the cooling chamber RC from the machine room RM is relatively low and opened when the magnitude of air pressure directing to the cooling chamber RC from the machine room RM is relatively high.

The drain cap 100 may include the air valve 150 configured to open or close the air flow path. The air valve 150 may be disposed inside the cap body 110. The air valve 150 may be configured to be movable relative to the cap body 110. The air valve 150 may open or close the air flow path while moving relative to the cap body 110.

The air valve 150 may close the air flow path in the descended position (hereinafter referred to as the “descended position”) as illustrated in FIG. 5. The air valve 150 may open the air flow path when ascended to the ascended position (hereinafter referred to as the “ascended position”) from the descended position as illustrated in FIG. 7. The air valve 150 may be configured to be movable between the descended position and the ascended position.

For example, a connecting hole 114h may be provided inside the cap body 110. The connecting hole 114h may be disposed between the first flow path P1 and the third flow path P3. The connecting hole 114h may connect the first flow path P1 and the third flow P3. The connecting hole 114h may be provided to allow air to flow from the third flow path P3 to the first flow path P1. As an example, the connecting hole 114h may be formed between an upper end of the partition 114 and an air valve support portion 115, which will be described later.

The air valve 150 may be configured to open and close the connecting hole 114h. The air valve 150 may close the connecting hole 114h in the descended position. The air valve 150 may close the air flow path by covering the connecting hole 114h in the descended position. The air valve 150 may open the connecting hole 114h in the ascended position. The air valve 150 may open the air flow path by being spaced apart from the connecting hole 114h in the ascended position. The air valve 150 may allow air to flow from the third flow path P3 to the first flow path P1 through the connecting hole 114h by being spaced apart from the connecting hole 114h in the ascended position.

The air valve 150 may be configured to be located in the descended position or to be descended from the ascended position, by a self-weight of the air valve 150. The air valve 150 may be configured to be ascended to the ascended position by the air pressure directing to the cooling chamber RC from the machine room RM.

The magnitude of air pressure, which is a reference at which the air valve 150 is ascended to open the air flow path or descended to close the air flow path, may vary depending on the weight of the air valve 150. The weight of the air valve 150 may be set to be sufficiently heavy such that even when the blowing fan in the cooling chamber RC rotates, the air valve 150 is not ascended just by a pressure thereof and does not open the air flow path, but to an appropriate weight such that when the door 30 is opened, the air valve 150 is ascended by the air pressure directing to the cooling chamber RC from the machine room RM to allow the door 30 to be easily opened.

The cap body 110 may include the air valve support portion 115 to support the air valve 150. As an example, the air valve support portion 115 may protrude from an inner wall of the cap body 110.

The air valve 150 may include a cover portion 151. When the air valve 150 is located in the descended position, the cover portion 151 may be supported by the cap body 110. When the air valve 150 is located in the descended position, the cover portion 151 may come into contact with the air valve support portion 115. In detail, the cover portion 151 may come into contact with an upper surface of the air valve support portion 115.

The cover portion 151 may cover the air flow path from above when the air valve 150 is located in the descended position. When the air valve 150 is ascended relative to the cap body 110, the cover portion 151 may be spaced apart from the air valve support portion 115 upward. At this time, the connecting hole 114h may be opened and the air flow path may be opened, so that air may flow from the third flow path P3 toward the first flow path P1.

The air valve 150 may be not ascended further than the ascended position, for example, by being limited from being ascended by the discharge plug 90 when ascended by air pressure. When the air valve 150 is located in the ascended position, the cover portion 151 may come into contact with a lower end of the discharge plug 90. As an example, one or more protrusions 151a protruding upward may be provided on an upper surface of the cover portion 151, and when the protrusions 151a come into contact with the discharge plug 90, the ascending of the air valve 150 may be stopped. The protrusion 151a may prevent the air valve 150 from being descended smoothly due to the surface tension of defrosted water by reducing a contact area between the cover portion 151 and the discharge plug 90.

However, the present disclosure is not limited thereto, and the cover portion 151 does not come into contact with the discharge plug 90 in the ascended position, and may come into contact with a structure provided separately inside the cap body 110 to limit the ascended position of the air valve 150.

The air valve 150 may include a hollow forming portion 152. The hollow forming portion 152 may have a hollow formed therein. For example, the second flow path P2 may be formed inside the hollow forming portion 152. The drain flow path may penetrate the inside of the hollow forming portion 152. Accordingly, the drain flow path may not be blocked or interfered with by the air valve 150, regardless of the location of the air valve 150.

The hollow forming portion 152 may be connected to the cover portion 151. The hollow forming portion 152 may extend downward from the cover portion 151. The cover portion 151 may extend from an upper portion of the hollow forming portion 152 in a radially outward direction.

When the air valve 150 is located in the descended position, the hollow forming portion 152 may cover the connecting hole 114h. For example, when the air valve 150 is located in the descended position, the connecting hole 114h may be covered by the upper portion of the hollow forming portion 152. The upper portion of the hollow forming portion 152 covering the connecting hole 114h may be disposed above an air flow hole 152h.

Alternatively, when the air valve 150 is located in the descended position, the connecting hole 114h may be covered by the cover portion 151, which may vary depending on the position of the connecting hole 114h, the shape of the air valve 150, etc.

The hollow forming portion 152 may be disposed inside the partition 114. Specifically, when the air valve 150 is located in the descended position, the hollow forming portion 152 may be disposed inside the partition 114. The hollow forming portion 152 may be disposed along an inner circumferential surface of the partition 114. As an example, the hollow forming portion 152 may be disposed above the valve hole forming portion 113b.

The air flow hole 152h may be formed in the hollow forming portion 152. The air flow hole 152h may be provided such that air outside the air valve 150 may flow into the air valve 150 through the air flow hole 152h. The air flow hole 152h may be formed along a circumference of the hollow forming portion 152. One or more of the air flow holes 152h may be formed along the circumference of the hollow forming portion 152.

As illustrated in FIG. 5, when the air valve 150 is located in the descended position, the air flow hole 152h may be covered by the partition 114. Therefore, because both the connecting hole 114h and the air flow hole 152h are covered, air in the machine room RM may not be introduced into the first flow path P1 through the third flow path P3.

As illustrated in FIG. 7, when the air valve 150 is ascended, air in the machine room RM may be introduced into the first flow path P1 through the outlet 112, the third flow path P3, and the connecting hole 114h, and may flow upward along an inner space of the hollow forming portion 152 through the air flow hole 152h. Accordingly, air may flow into the cooling chamber RC through the inlet 111.

The water valve 130 may be disposed below the air valve 150. The water valve 130 may be ascended or descended below the air valve 150. The air valve 150 may be ascended or descended above the water valve 130.

Hereinafter, the flow of defrosted water or air in the drain cap 100 according to an embodiment of the present disclosure will be described with reference to FIGS. 5 to 7.

As illustrated in FIG. 5, when defrosted water is not drained, the water valve 130 may cover the valve hole 113a by being ascended by the repulsive force between the fixed magnet 120 and the moving magnet 131, and the drain flow path may be closed. In addition, when the refrigerator 1 does not operate or the blowing fan in the cooling chamber RC only operates and the air pressure directing to the cooling chamber RC from the machine room RM is not sufficiently high, the air valve 150 may cover the connecting hole 114h by being descended by the self-weight, and the air flow path may be closed.

As illustrated in FIG. 6, when defrosted water is introduced into the drain cap 100 from the evaporator 50, the water valve 130 may be pushed down and descended by the defrosted water, and the drain flow path may be opened as the valve hole 113a is opened. The defrosted water passed through the valve hole 113a may be drained into the machine room RM through the outlet 112.

As illustrated in FIG. 7, when the air pressure directing to the cooling chamber RC from the machine room RM is high enough to ascend the air valve 150 (e.g., when the door 30 is opened), the air valve 150 may be pushed upward and ascended by the air pressure, and the air flow path may be opened as the connecting hole 114h is opened. Air in the machine room RM may be introduced into the third flow path P3 through the outlet 112, sequentially pass through the third flow path P3, the connecting hole 114h, and the air flow hole 152h, and then move to the cooling chamber RC side through the inlet 111.

As illustrated in FIGS. 3 to 7, the outlet 112 of the cap body 110 may have a shape of penetrating in the vertical direction. Accordingly, when the air flow path is opened, air may pass through the outlet 112 substantially vertically upward and be introduced into the cap body 110. According to the structure of the outlet 112 as described above, external foreign substances such as dust may not accumulate around the outlet 112, and the outlet 112 may be effectively prevented from being blocked by foreign substances.

FIG. 8 is a view illustrating that a cap body and magnet support of the drain cap of the refrigerator according to an embodiment of the present disclosure are coupled.

Referring to FIG. 8, the magnet support 140 of the drain cap 100 of the refrigerator 1 according to an embodiment of the present disclosure may be configured to be couplable to or detachable from the cap body 110.

The magnet support 140 may include the fixed portion 143 provided to be coupled to the cap body 110. The cap body 110 may include the supporter fixing portion 116, and the magnet support 140 may be fixed to the cap body 110 as the fixed portion 143 is coupled to the supporter fixing portion 116.

As an example, the supporter fixing portion 116 may protrude downward from the valve hole forming portion 113b. The magnet support 140 may be coupled to the supporter fixing portion 116 from below and may be separated downward from the supporter fixing portion 116.

As an example, the supporter fixing portion 116 may have a hook shape, and the fixed portion 143 may be coupled to the cap body 110 by being caught on the supporter fixing portion 116.

The fixed portion 143 may include a fixed portion hole 143a. For example, the fixed portion hole 143a may have a shape of being concavely recessed in an inward direction from an outer circumference of the fixed portion 143.

According to this structure, the magnet support 140 may be coupled to the cap body 110 through a process of positioning the magnet support 140 such that the supporter fixing portion 116 passes through the fixed portion hole 143a, and then rotating the magnet support 140 such that the fixed portion 143 is caught on the supporter fixing portion 116. Conversely, the magnet support 140 may be separated from the cap body 110 through a process of rotating the magnet support 140 such that the supporter fixing portion 116 is positioned in the fixed portion hole 143a in a state in which the fixed portion 143 is caught on the supporter fixing portion 116, and then moving the magnet support 140 downward.

By the structure of the magnet support 140 and the cap body 110 as described above, assemblability and productivity of the drain cap 100 may be improved.

The configurations and operations of the drain cap 100 included in the refrigerator 1 according to an embodiment have been described in detail above with reference to FIGS. 1 to 8. Hereinafter, drain caps 200, 300, 400, 500, and 600 according to various embodiments will be described.

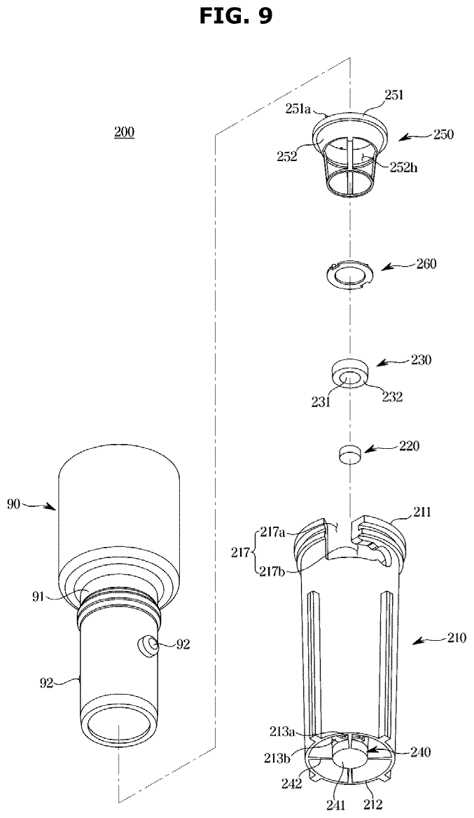

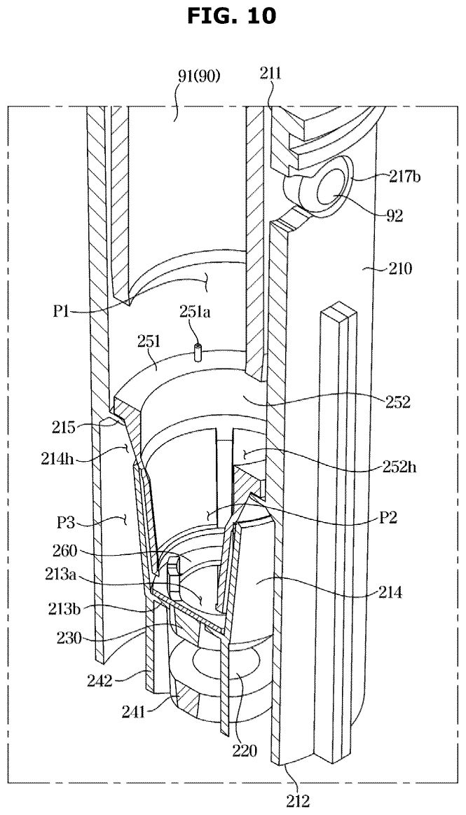

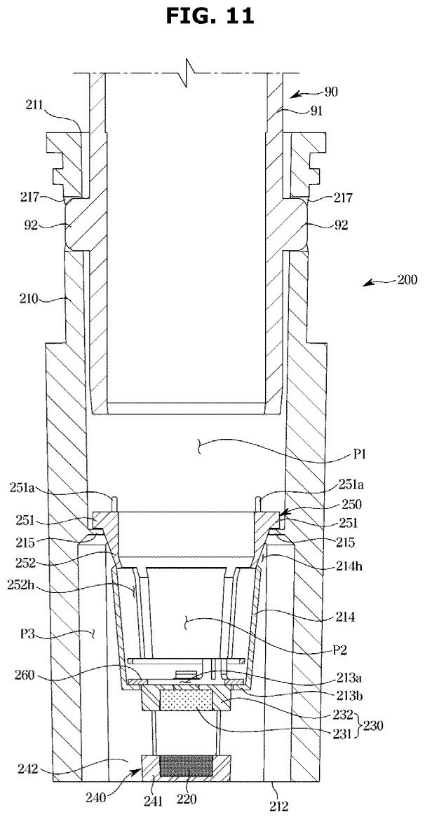

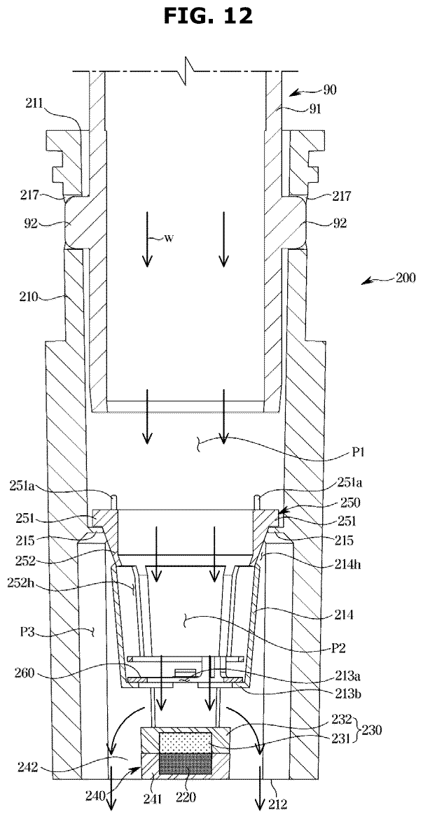

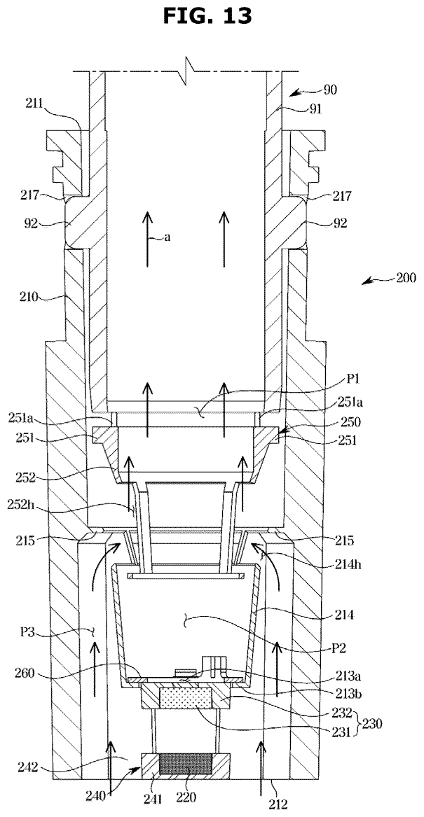

FIG. 9 is an exploded view illustrating the discharge plug and components of a drain cap of the refrigerator according to an embodiment of the present disclosure. FIG. 10 is a cross-sectional perspective view illustrating that the discharge plug and drain cap of FIG. 9 are cut away in an assembled state. FIG. 11 is a cross-sectional view illustrating that the discharge plug and drain cap of FIG. 9 are cut away in the assembled state. FIG. 12 is a cross-sectional view illustrating that defrosted water is being drained in the state in which the discharge plug and drain cap of FIG. 9 are assembled. FIG. 13 is a cross-sectional view illustrating that air is being introduced from the machine room in the state in which the discharge plug and drain cap of FIG. 9 are assembled.

An arrow w in FIG. 12 indicates a drainage direction of defrosted water. An arrow a in FIG. 7 indicates an inflow direction of air.

Some components of the refrigerator 1 according to an embodiment of the present disclosure illustrated in FIGS. 9 to 13 corresponding to those in the embodiment illustrated in FIGS. 1 to 8 may be given the same reference numerals, and descriptions thereof may be omitted.

Referring to FIGS. 9 to 13, the refrigerator 1 according to an embodiment of the present disclosure may include the drain cap 200.

The drain cap 200 may include a cap body 210. The cap body 210 may be connected with the drain pipe 80. The cap body 210 may be connected with the discharge plug 90.

The cap body 210 may be coupled with the discharge plug 90. For example, the cap body 210 may include a plug coupling portion 217 provided to be coupled to the discharge plug 90. The discharge plug 90 and the cap body 210 may be coupled to each other as the coupling protrusion 92 penetrates the plug coupling portion 217 and is caught thereon.

The plug coupling portion 217 may include an insertion portion 217a extending along a longitudinal direction (or an axial direction) of the cap body 210, and a coupling portion 217b extending from the insertion portion 217a along a direction different from the longitudinal direction of the cap body 210 (e.g., a circumferential direction of the cap body 210). A process of coupling or separating the discharge plug 90 and the cap body 210 using a structure of the plug coupling portion 217 and the coupling protrusion 92 is the same as in the above-described embodiment, and therefore a detailed description thereof will be omitted.

In addition, according to various embodiments, the drain cap 200 may include various structures for being coupled with the discharge plug 90.

The cap body 210 may include an inlet 211 provided to allow defrosted water to be introduced or air to be discharged, and an outlet 212 provided to allow defrosted water to be discharged or air to be introduced. The cap body 210 may have a flow path formed therein. The flow path of the cap body 210 may be provided such that defrosted water or air flows therethrough.

In detail, the cap body 210 may include a first flow path P1, a second flow path P2, and a third flow path P3. The first flow path P1 may extend from the inlet 211. The second flow path P2 may extend between the first flow path P1 and the outlet 212. The third flow path P3 may extend between the first flow path P1 and the outlet 212. For example, the second flow path P2 and the third flow path P3 may be partitioned from each other in a radial direction of the cap body 210.

The cap body 210 may include a partition 214 configured to partition the second flow path P2 and the third flow path P3. For example, the partition 214 may partition the second flow path P2 and the third flow path P3 in the radial direction. For example, the second flow path P2 may be provided inside the partition 214. For example, the third flow path P3 may be provided outside the partition 214.

The partition 214 may have a hollow shape of forming a flow path therein. The partition 214 may have a hollow shape of forming the second flow path P2 therein. The partition 214 may have a shape of surrounding the second flow path P2.

A drain flow path may be formed inside the cap body 210 such that defrosted water is drained therethrough. The first flow path P1 may form a portion of the drain flow path. The second flow path P2 may form another portion of the drain flow path.

An air flow path may be formed inside the cap body 210 such that air flows from the machine room RM toward the cooling chamber RC therethrough. The first flow path P1 may form a portion of the air flow path. The third flow path P3 may form another portion of the air flow path.

Portions of the drain flow path and air flow path may be partitioned from each other by the partition 214. The partition 214 may partition a portion of the drain flow path and a portion of the air flow path in the radial direction. For example, a portion of the drain flow path may be provided inside the partition 214. For example, a portion of the air flow path may be provided outside the partition 214.

The drain cap 200 may include a water valve 230 configured to open or close the drain flow path. The water valve 230 may be configured to be movable inside the cap body 210.

The water valve 230 may close the drain flow path in an ascended position as illustrated in FIG. 11. The water valve 230 may open the drain flow path in a descended position as illustrated in FIG. 12. The water valve 230 may be configured to be movable between the ascended position and the descended position.

For example, the cap body 210 may include a valve hole 213a. The valve hole 213a may be provided on the drain flow path. The drain flow path may pass through the valve hole 213a. When the valve hole 213a is opened, defrosted water may be allowed to flow and be drained along the drain flow path, and when the valve hole 213a is closed, defrosted water may be limited from being drained along the drain flow path. The water valve 230 may be configured to open and close the valve hole 213a. The water valve 230 may close the drain flow path by covering the valve hole 213a in the ascended position. The water valve 230 may open the drain flow path by being spaced apart from the valve hole 213a in the descended position.

The cap body 210 may include a valve hole forming portion 213b. The valve hole forming portion 213b may be provided along a circumference of the valve hole 213a. The valve hole forming portion 213b may be disposed above the water valve 230.

The valve hole 213a may be disposed on the second flow path P2. The second flow path P2 may pass through the valve hole forming portion 213b.

The valve hole 213a may be disposed on an inner side of the partition 214. The valve hole forming portion 213b may be disposed on the inner side of the partition 214.

The valve hole 213a may be provided at a lower portion of the partition 214. The valve hole forming portion 213b may be provided at the lower portion of the partition 214.

According to an embodiment, a width of the valve hole 213a may be larger than a width of the water valve 230. In this case, in a process of assembling the water valve 230 to the cap body 210, the water valve 230 may be located at a position lower than the valve hole 213a as the water valve passes through the valve hole 213a in a direction of directing from top to bottom. In this structure, in order to prevent the water valve 230 from being ascended further through the valve hole 213a in the ascended position, a valve limiting part 260 may be disposed above the valve hole forming portion 213b. A hole through which the drain flow path passes may be formed on the valve limiting part 260, and defrosted water may be discharged downward by sequentially passing through the hole of the valve limiting part 260 and the valve hole 213a. A width of the hole of the valve limiting part 260 may be smaller than the width of the water valve 230.

The valve limiting part 260 may be detachably coupled to the valve hole forming portion 213b. In this case, the assemblability of the water valve 230 may be improved. However, the present disclosure is not limited thereto, and the valve limiting part 260 limiting an ascending range of the water valve 230 may be formed integrally with the valve hole forming portion 213b.

The water valve 230 may include a moving magnet 231. The drain cap 200 may include a fixed magnet 220 configured to be fixed to the cap body 210. The water valve 230 may be configured to be movable relative to the cap body 210 using a magnetic force between the moving magnet 231 and the fixed magnet 220.

The water valve 230 may include a water valve body 232 configured to support the moving magnet 231. Alternatively, the water valve 230 may not include the separate water valve body 232, and the entire water valve 230 may be configured as a magnetic body.

The water valve 230 may be ascended by the magnetic force between the fixed magnet 220 and the moving magnet 231. The water valve 230 may be located in the ascended position by the magnetic force between the fixed magnet 220 and the moving magnet 231. The water valve 230 may be configured to close the valve hole 213a and the drain flow path when ascended by the magnetic force between the fixed magnet 220 and the moving magnet 231.

For example, the water valve 230 may be configured to close the valve hole 213a and the drain flow path by being ascended by a repulsive force between the moving magnet 231 and the fixed magnet 220. The moving magnet 231 may be disposed above the fixed magnet 220, and an upward magnetic force by the fixed magnet 220 may be applied to the moving magnet 231. Accordingly, the water valve 230 may be ascended or kept in the ascended position relative to the cap body 210.

The water valve 230 may be descended by defrosted water flowing along the drain flow path. The water valve 230 may be located in the descended position by defrosted water flowing along the drain flow path. The water valve 230 may be configured to open the valve hole 213a and the drain flow path when descended by defrosted water flowing along the drain flow path.

The drain cap 200 may include a magnet support 240 configured to support the fixed magnet 220. The magnet support 240 may fix the fixed magnet 220 to the cap body 210.

The magnet support 240 may include a magnet support portion 241 provided to support the fixed magnet 220. The fixed magnet 220 may be coupled to the magnet support portion 241.

The magnet support portion 241 may be disposed below the moving magnet 231. The magnet support portion 241 may be disposed below the water valve 230. The water valve 230 may come into contact with the magnet support portion 241 when reaching the descended position.

Unlike the magnet support 140 according to the embodiment of FIGS. 1 to 8, the magnet support 240 in this embodiment may be formed integrally with the cap body 210. The magnet support 240 may be defined as one component of the cap body 210. The magnet support 240 may be formed integrally with at least the valve hole forming portion 213b of the cap body 210.

The magnet support 240 may include a connecting portion 242 provided to connect the magnet support portion 241 and the cap body 210. The connecting portion 242 may connect the magnet support portion 241 and the valve hole forming portion 213b. The connecting portion 242 may extend substantially downward from the valve hole forming portion 213b toward the magnet support portion 241. As an example, the connecting portion 242 may extend in a vertical direction between the magnet support portion 241 and the valve hole forming portion 213b.

The magnet support 240 may be formed such that defrosted water may pass therethrough. The magnet support 240 may be formed such that water may pass therethrough in at least an area between the valve hole 213a and the magnet support portion 241. For example, the magnet support 240 may include a plurality of the connecting portions 242 spaced apart from each other, and defrosted water may pass between the plurality of connecting portions 242.

The magnet support 240 may be configured to guide a movement of the water valve 230. For example, the connecting portion 242 may guide the movement of the water valve 230. The connecting portion 242 may guide the movement of the water valve 230 by being in contact with an outer circumferential surface of the water valve 230. In detail, the plurality of connecting portions 242 may guide the movement of the water valve 230 by being disposed to surround the outer circumferential surface of the water valve 230. The water valve 230 may be movable in a direction parallel to a direction in which the connecting portion 242 extends. In this respect, the connecting portion 242 may also be referred to as the “movement guide 242.”

In various embodiments, the structure of fixing the fixed magnet 220 to the cap body 210 is not limited to that described above, and the fixed magnet 220 may be fixed to the cap body 210 by various structures.

The drain cap 200 may include the air valve 250 configured to open or close the air flow path. The air valve 250 may be disposed inside the cap body 210. The air valve 250 may be configured to be movable relative to the cap body 210.

The air valve 250 may close the air flow path in the descended position as illustrated in FIG. 11. The air valve 250 may open the air flow path in the ascended position as illustrated in FIG. 13. The air valve 250 may be configured to be movable between the descended position and the ascended position.

For example, a connecting hole 214h may be provided inside the cap body 210. The connecting hole 214h may connect the first flow path P1 and the third flow path P3. As an example, the connecting hole 214h may be formed between an upper end of the partition 214 and an air valve support portion 215.

The air valve 250 may be configured to open and close the connecting hole 214h. The air valve 250 may close the connecting hole 214h in the descended position. The air valve 250 may close the air flow path by covering the connecting hole 214h in the descended position. The air valve 250 may open the connecting hole 214h in the ascended position. The air valve 250 may open the air flow path by being spaced apart from the connecting hole 214h in the ascended position.

The air valve 250 may be configured to be located in the descended position or to be descended from the ascended position, by a self-weight of the air valve 250. The air valve 250 may be configured to be ascended to the ascended position by the air pressure directing to the cooling chamber RC from the machine room RM.

The air valve 250 may include a cover portion 251. When the air valve 250 is located in the descended position, the cover portion 251 may be supported by the cap body 210. When the air valve 250 is located in the descended position, the cover portion 251 may come into contact with the air valve support portion 215 of the cap body 210.

The cover portion 251 may cover the air flow path from above when the air valve 250 is located in the descended position. When the air valve 250 is ascended relative to the cap body 210, the cover portion 251 may be spaced apart from the air valve support portion 215 upward. At this time, the connecting hole 214h may be opened and the air flow path may be opened, so that air may flow from the third flow path P3 toward the first flow path P1.

The air valve 250 may be not ascended further than the ascended position, for example, by being limited from being ascended by the discharge plug 90 when ascended by air pressure. When the air valve 250 is located in the ascended position, the cover portion 251 may come into contact with the lower end of the discharge plug 90. As an example, one or more protrusions 251a protruding upward may be provided on an upper surface of the cover portion 251, and when the protrusions 251a come into contact with the discharge plug 90, the ascending of the air valve 250 may be stopped.

The air valve 250 may include a hollow forming portion 252. The hollow forming portion 252 may have a hollow formed therein. For example, the second flow path P2 may be formed inside the hollow forming portion 252. The drain flow path may penetrate the inside of the hollow forming portion 252.

When the air valve 250 is located in the descended position, the hollow forming portion 252 may cover the connecting hole 114h. For example, when the air valve 250 is located in the descended position, the connecting hole 214h may be covered by an upper portion of the hollow forming portion 252. The upper portion of the hollow forming portion 252 covering the connecting hole 214h may be disposed above an air flow hole 252h.

Alternatively, when the air valve 250 is located in the descended position, the connecting hole 214h may be covered by the cover portion 251.

When the air valve 250 is located in the descended position, the hollow forming portion 252 may be disposed on an inner side of the partition 214.

The air flow hole 252h may be formed in the hollow forming portion 252. The air flow hole 252h may be provided such that air outside the air valve 250 may flow into the air valve 250 through the air flow hole 252h. The air flow hole 252h may be formed along a circumference of the hollow forming portion 252. One or more of the air flow holes 252h may be formed along the circumference of the hollow forming portion 252.

As illustrated in FIG. 11, when the air valve 250 is located in the descended position, the air flow hole 252h may be covered by the partition 214. Therefore, because both the connecting hole 214h and the air flow hole 252h are covered, air in the machine room RM may not be introduced into the first flow path P1 through the third flow path P3.

As illustrated in FIG. 13, when the air valve 250 is ascended, air in the machine room RM may be introduced into the first flow path P1 through the outlet 212, the third flow path P3, and the connecting hole 214h, and may flow upward along an inner space of the hollow forming portion 252 through the air flow hole 252h. Accordingly, air may flow into the cooling chamber RC through the inlet 211.

Hereinafter, the flow of defrosted water or air in the drain cap 200 according to an embodiment of the present disclosure will be described with reference to FIGS. 11 to 13.

As illustrated in FIG. 11, when defrosted water is not drained, the water valve 230 may cover the valve hole 213a by being ascended by the repulsive force between the fixed magnet 220 and the moving magnet 231, and the drain flow path may be closed. In addition, when the air pressure directing to the cooling chamber RC from the machine room RM is not sufficiently high, the air valve 250 may cover the connecting hole 214h by being descended by the self-weight, and the air flow path may be closed.

As illustrated in FIG. 12, when defrosted water is introduced into the drain cap 200 from the evaporator 50, the water valve 230 may be pushed down and descended by the defrosted water, and the drain flow path may be opened as the valve hole 213a is opened. The defrosted water passed through the valve hole 213a may be drained into the machine room RM through the outlet 212.

As illustrated in FIG. 13, when the air pressure directing to the cooling chamber RC from the machine room RM is high enough to ascend the air valve 250 (e.g., when the door 30 is opened), the air valve 250 may be pushed upward and ascended by the air pressure, and the air flow path may be opened as the connecting hole 214h is opened. Air in the machine room RM may be introduced into the third flow path P3 through the outlet 212, sequentially pass through the third flow path P3, the connecting hole 214h, and the air flow hole 252h, and then move to the cooling chamber RC side through the inlet 211.

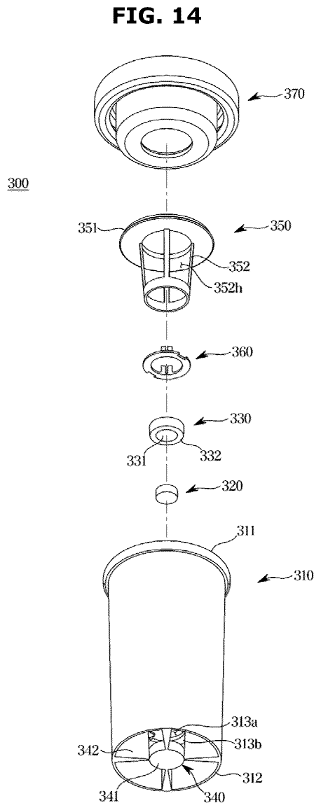

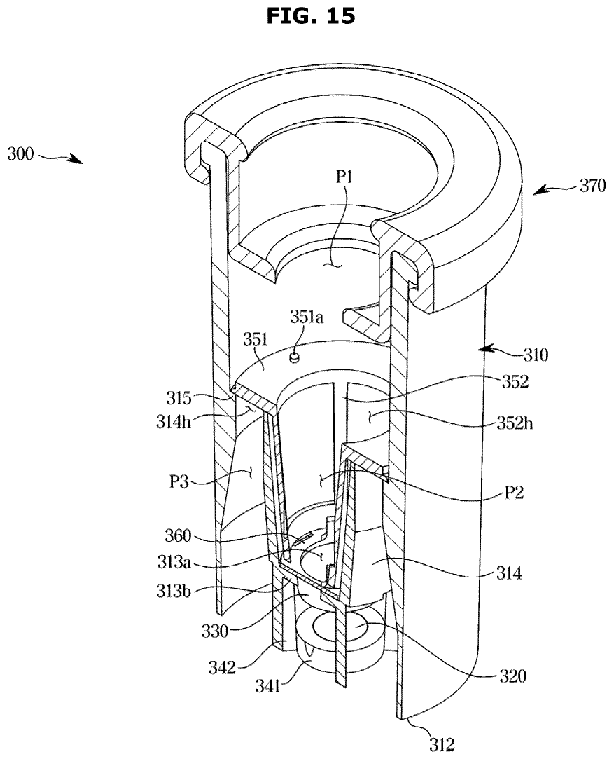

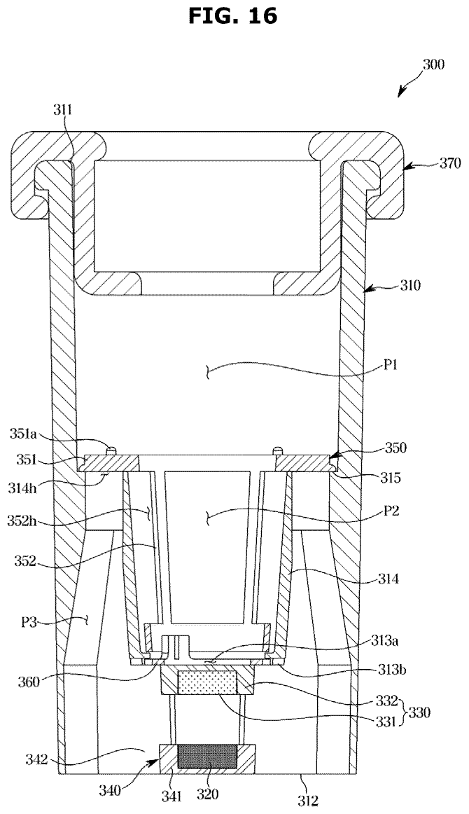

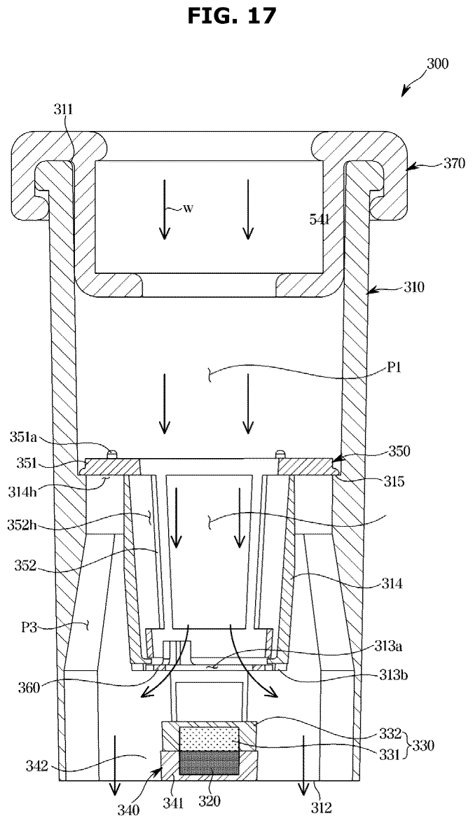

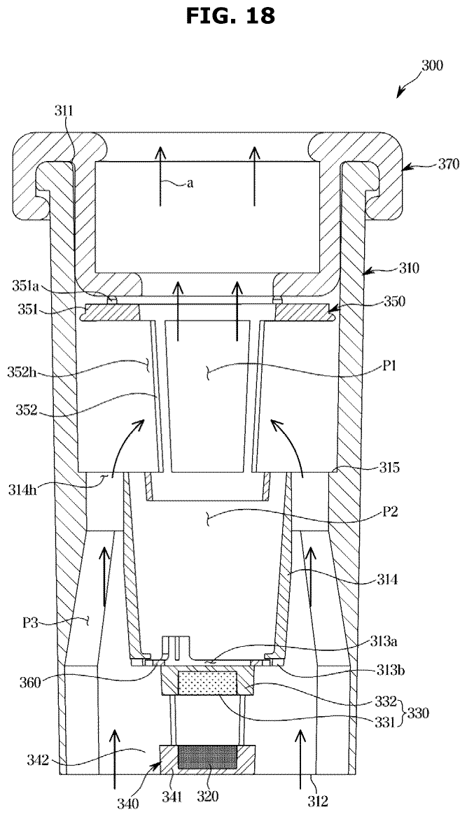

FIG. 14 is an exploded view illustrating components of a drain cap of the refrigerator according to an embodiment of the present disclosure. FIG. 15 is a cross-sectional perspective view illustrating that the drain cap of FIG. 14 is cut away in an assembled state. FIG. 16 is a cross-sectional view illustrating that the drain cap of FIG. 14 is cut away in the assembled state. FIG. 17 is a cross-sectional view illustrating that defrosted water is being drained in the state in which the drain cap of FIG. 14 is assembled. FIG. 18 is a cross-sectional view illustrating that air is being introduced from the machine room in the state in which the drain cap of FIG. 14 is assembled.

An arrow w in FIG. 17 indicates a drainage direction of defrosted water. An arrow a in FIG. 18 indicates an inflow direction of air.

Some components of the refrigerator 1 according to an embodiment of the present disclosure illustrated in FIGS. 14 to 18 corresponding to those in the embodiments illustrated in FIGS. 1 to 13 may be given the same reference numerals, and descriptions thereof may be omitted.

Referring to FIGS. 14 to 18, the refrigerator 1 according to an embodiment of the present disclosure may include the drain cap 300.

The drain cap 300 may include a cap body 310. The cap body 310 may be connected with the drain pipe 80. The cap body 310 may be connected with the discharge plug 90.

Unlike the previous embodiments, the drain cap 300 in the present embodiment may include a plug coupling member 370 provided to couple the discharge plug 90 to the cap body 310. The plug coupling member 370 may be coupled to an inlet 311 side of the cap body 310. The discharge plug 90 may be connected to the cap body 310 by being fitted into the plug coupling member 370.

As an example, the plug coupling member 370 may include various elastic materials such as rubber.

In addition, according to various embodiments, the drain cap 300 may include various structures for being coupled with the discharge plug 90.

The cap body 310 may include the inlet 311 provided to allow defrosted water to be introduced or air to be discharged, and an outlet 312 provided to allow defrosted water to be discharged or air to be introduced. The cap body 310 may have a flow path formed therein. The flow path of the cap body 310 may be provided such that defrosted water or air flows therethrough.

In detail, the cap body 310 may include a first flow path P1, a second flow path P2, and a third flow path P3. The first flow path P1 may extend from the inlet 311. The second flow path P2 may extend between the first flow path P1 and the outlet 312. The third flow path P3 may extend between the first flow path P1 and the outlet 312. For example, the second flow path P2 and the third flow path P3 may be partitioned from each other in a radial direction of the cap body 310.

The cap body 310 may include a partition 314 configured to partition the second flow path P2 and the third flow path P3. For example, the partition 314 may partition the second flow path P2 and the third flow path P3 in the radial direction. For example, the second flow path P2 may be provided inside the partition 314. For example, the third flow path P3 may be provided outside the partition 314.

The partition 314 may have a hollow shape of forming a flow path therein. The partition 314 may have a hollow shape of forming the second flow path P2 therein. The partition 314 may have a shape of surrounding the second flow path P2.

A drain flow path may be formed inside the cap body 310 such that defrosted water is drained therethrough. The first flow path P1 may form a portion of the drain flow path. The second flow path P2 may form another portion of the drain flow path.

An air flow path may be formed inside the cap body 310 such that air flows from the machine room RM toward the cooling chamber RC therethrough. The first flow path P1 may form a portion of the air flow path. The third flow path P3 may form another portion of the air flow path.

Portions of the drain flow path and air flow path may be partitioned from each other by the partition 314. The partition 314 may partition a portion of the drain flow path and a portion of the air flow path in the radial direction. For example, a portion of the drain flow path may be provided inside the partition 314. For example, a portion of the air flow path may be provided outside the partition 314.

The drain cap 300 may include a water valve 330 configured to open or close the drain flow path. The water valve 330 may be configured to be movable inside the cap body 310.

The water valve 330 may close the drain flow path in an ascended position as illustrated in FIG. 16. The water valve 330 may open the drain flow path in a descended position as illustrated in FIG. 17. The water valve 330 may be configured to be movable between the ascended position and the descended position.

For example, the cap body 310 may include a valve hole 313a. The valve hole 313a may be provided on the drain flow path. The drain flow path may pass through the valve hole 313a. When the valve hole 313a is opened, defrosted water may be allowed to flow and be drained along the drain flow path, and when the valve hole 313a is closed, defrosted water may be limited from being drained along the drain flow path. The water valve 330 may be configured to open and close the valve hole 313a. The water valve 330 may close the drain flow path by covering the valve hole 313a in the ascended position. The water valve 330 may open the drain flow path by being spaced apart from the valve hole 313a in the descended position.

The cap body 310 may include a valve hole forming portion 313b. The valve hole forming portion 313b may be provided along a circumference of the valve hole 313a. The valve hole forming portion 313b may be disposed above the water valve 330.

The valve hole 313a may be disposed on the second flow path P2. The second flow path P2 may pass through the valve hole forming portion 313b.

The valve hole 313a may be disposed on an inner side of the partition 314. The valve hole forming portion 313b may be disposed on the inner side of the partition 314.

The valve hole 313a may be provided at a lower portion of the partition 314. The valve hole forming portion 313b may be provided at the lower portion of the partition 314.

According to an embodiment, a width of the valve hole 313a may be larger than a width of the water valve 330. In this structure, in order to prevent the water valve 330 from being ascended further through the valve hole 313a in the ascended position, a valve limiting part 360 may be disposed above the valve hole forming portion 313b. A hole through which the drain flow path passes may be formed on the valve limiting part 360, and defrosted water may be discharged downward by sequentially passing through the hole of the valve limiting part 360 and the valve hole 313a. A width of the hole of the valve limiting part 360 may be smaller than the width of the water valve 330.

The valve limiting part 360 may be detachably coupled to the valve hole forming portion 313b. In this case, the assemblability of the water valve 330 may be improved. However, the present disclosure is not limited thereto, and the valve limiting part 360 limiting an ascending range of the water valve 330 may be formed integrally with the valve hole forming portion 313b.

The water valve 330 may include a moving magnet 331. The drain cap 300 may include a fixed magnet 320 configured to be fixed to the cap body 310. The water valve 330 may be configured to be movable relative to the cap body 310 using a magnetic force between the moving magnet 331 and the fixed magnet 320.

The water valve 330 may include a water valve body 332 configured to support the moving magnet 331. Alternatively, the water valve 330 may not include the separate water valve body 332, and the entire water valve 330 may be configured as a magnetic body.

The water valve 330 may be ascended by the magnetic force between the fixed magnet 320 and the moving magnet 331. The water valve 330 may be located in the ascended position by the magnetic force between the fixed magnet 320 and the moving magnet 331. The water valve 330 may be configured to close the valve hole 313a and the drain flow path when ascended by the magnetic force between the fixed magnet 320 and the moving magnet 331.

For example, the water valve 330 may be configured to close the drain flow path by being ascended by a repulsive force between the moving magnet 331 and the fixed magnet 320. The moving magnet 331 may be disposed above the fixed magnet 320, and an upward magnetic force by the fixed magnet 320 may be applied to the moving magnet 331. Accordingly, the water valve 330 may be ascended or kept in the ascended position relative to the cap body 310.

The water valve 330 may be descended by defrosted water flowing along the drain flow path. The water valve 330 may be located in the descended position by defrosted water flowing along the drain flow path. The water valve 330 may be configured to open the valve hole 313a and the drain flow path when descended by defrosted water flowing along the drain flow path.

The drain cap 300 may include a magnet support 340 configured to support the fixed magnet 320. The magnet support 340 may fix the fixed magnet 320 to the cap body 310.

The magnet support 340 may include a magnet support portion 341 provided to support the fixed magnet 320. The fixed magnet 320 may be coupled to the magnet support portion 341.

The magnet support portion 341 may be disposed below the moving magnet 331. The magnet support portion 341 may be disposed below the water valve 330. The water valve 330 may come into contact with the magnet support portion 341 when reaching the descended position.

The magnet support 340 may be formed integrally with the cap body 310. The magnet support 340 may be defined as one component of the cap body 310. The magnet support 340 may be formed integrally with at least the valve hole forming portion 313b of the cap body 310.

The magnet support 340 may include a connecting portion 342 provided to connect the magnet support portion 341 and the cap body 310. The connecting portion 342 may connect the magnet support portion 341 and the valve hole forming portion 313b. The connecting portion 342 may extend substantially downward from the valve hole forming portion 313b toward the magnet support portion 341. As an example, the connecting portion 342 may extend in a vertical direction between the magnet support portion 341 and the valve hole forming portion 313b.

The magnet support 340 may be formed such that defrosted water may pass therethrough. The magnet support 340 may be formed such that water may pass therethrough in at least an area between the valve hole 313a and the magnet support portion 341. For example, the magnet support 340 may include a plurality of the connecting portions 342 spaced apart from each other, and defrosted water may pass between the plurality of connecting portions 342.

The magnet support 340 may be configured to guide a movement of the water valve 330. For example, the connecting portion 342 may guide the movement of the water valve 330. The connecting portion 342 may guide the movement of the water valve 330 by being in contact with an outer circumferential surface of the water valve 330. In detail, the plurality of connecting portions 342 may guide the movement of the water valve 330 by being disposed to surround the outer circumferential surface of the water valve 330. The water valve 330 may be movable in a direction parallel to a direction in which the connecting portion 342 extends. In this respect, the connecting portion 342 may also be referred to as the “movement guide 342.”

In various embodiments, the structure of fixing the fixed magnet 320 to the cap body 310 is not limited to that described above, and the fixed magnet 320 may be fixed to the cap body 310 by various structures.

The drain cap 300 may include the air valve 350 configured to open or close the air flow path. The air valve 350 may be disposed inside the cap body 310. The air valve 350 may be configured to be movable relative to the cap body 310.

The air valve 350 may close the air flow path in the descended position as illustrated in FIG. 16. The air valve 350 may open the air flow path in the ascended position as illustrated in FIG. 18. The air valve 350 may be configured to be movable between the descended position and the ascended position.

For example, a connecting hole 314h may be provided inside the cap body 310. The connecting hole 314h may connect the first flow path P1 and the third flow path P3. As an example, the connecting hole 314h may be formed between an upper end of the partition 314 and an air valve support portion 315.

The air valve 350 may be configured to open and close the connecting hole 314h. The air valve 350 may close the connecting hole 314h in the descended position. The air valve 350 may close the air flow path by covering the connecting hole 314h in the descended position. The air valve 350 may open the connecting hole 314h in the ascended position. The air valve 350 may open the air flow path by being spaced apart from the connecting hole 314h in the ascended position.

The air valve 350 may be configured to be located in the descended position or to be descended from the ascended position, by a self-weight of the air valve 350. The air valve 350 may be configured to be ascended to the ascended position by the air pressure directing to the cooling chamber RC from the machine room RM.

The air valve 350 may include a cover portion 351. When the air valve 350 is located in the descended position, the cover portion 351 may be supported by the cap body 310. When the air valve 350 is located in the descended position, the cover portion 351 may come into contact with the air valve support portion 315 of the cap body 310.

The cover portion 351 may cover the air flow path from above when the air valve 350 is located in the descended position. When the air valve 350 is ascended relative to the cap body 310, the cover portion 351 may be spaced apart from the air valve support portion 315 upward. At this time, the connecting hole 314h may be opened and the air flow path may be opened, so that air may flow from the third flow path P3 toward the first flow path P1.

The air valve 350 may be not ascended further than the ascended position, for example, by being limited from being ascended by the plug coupling member 370 when ascended by air pressure. When the air valve 350 is located in the ascended position, the cover portion 351 may come into contact with a lower end of the plug coupling member 370. As an example, one or more protrusions 351a protruding upward may be provided on an upper surface of the cover portion 351, and when the protrusions 351a come into contact with the plug coupling member 370, the ascending of the air valve 350 may be stopped.

The air valve 350 may include a hollow forming portion 352. The hollow forming portion 352 may have a hollow formed therein. For example, the second flow path P2 may be formed inside the hollow forming portion 352. The drain flow path may penetrate the inside of the hollow forming portion 352.

When the air valve 350 is located in the descended position, the hollow forming portion 352 may be disposed inside the partition 314.

The air flow hole 352h may be formed in the hollow forming portion 352. The air flow hole 352h may be provided such that air outside the air valve 350 may flow into the air valve 350 through the air flow hole 352h. The air flow hole 352h may be formed along a circumference of the hollow forming portion 352. One or more of the air flow holes 352h may be formed along the circumference of the hollow forming portion 352.

As illustrated in FIG. 16, when the air valve 350 is located in the descended position, the air flow hole 352h may be covered by the partition 314. Therefore, because both the connecting hole 314h and the air flow hole 352h are covered, air in the machine room RM may not be introduced into the first flow path P1 through the third flow path P3.

As illustrated in FIG. 18, when the air valve 350 is ascended, air in the machine room RM may be introduced into the first flow path P1 through the outlet 312, the third flow path P3, and the connecting hole 314h, and may flow upward along an inner space of the hollow forming portion 352 through the air flow hole 352h. Accordingly, air may flow into the cooling chamber RC through the inlet 311.

Hereinafter, the flow of defrosted water or air in the drain cap 300 according to an embodiment of the present disclosure will be described with reference to FIGS. 16 to 18.

As illustrated in FIG. 16, when defrosted water is not drained, the water valve 330 may cover the valve hole 313a by being ascended by the repulsive force between the fixed magnet 320 and the moving magnet 331, and the drain flow path may be closed. In addition, when the air pressure directing to the cooling chamber RC from the machine room RM is not sufficiently high, the air valve 350 may cover the connecting hole 314h by being descended by the self-weight, and the air flow path may be closed.

As illustrated in FIG. 17, when defrosted water is introduced into the drain cap 300 from the evaporator 50, the water valve 330 may be pushed down and descended by the defrosted water, and the drain flow path may be opened as the valve hole 313a is opened. The defrosted water passed through the valve hole 313a may be drained into the machine room RM through the outlet 312.

As illustrated in FIG. 18, when the air pressure directing to the cooling chamber RC from the machine room RM is high enough to ascend the air valve 350 (e.g., when the door 30 is opened), the air valve 350 may be pushed upward and ascended by the air pressure, and the air flow path may be opened as the connecting hole 314h is opened. Air in the machine room RM may be introduced into the third flow path P3 through the outlet 312, sequentially pass through the third flow path P3, the connecting hole 314h, and the air flow hole 352h, and then move to the cooling chamber RC side through the inlet 311.

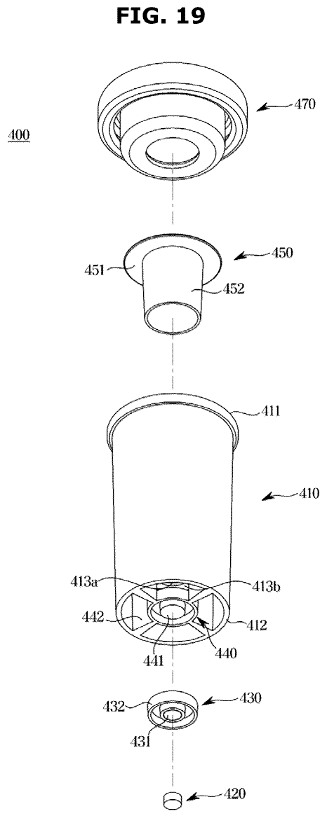

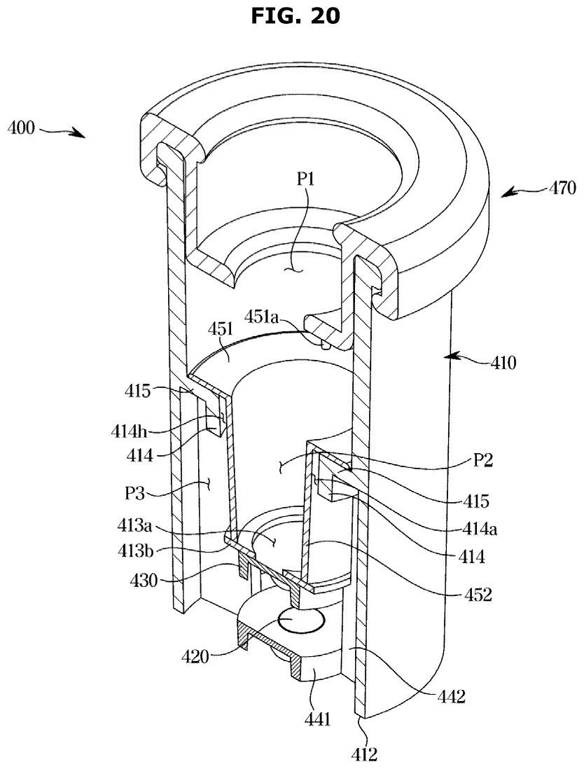

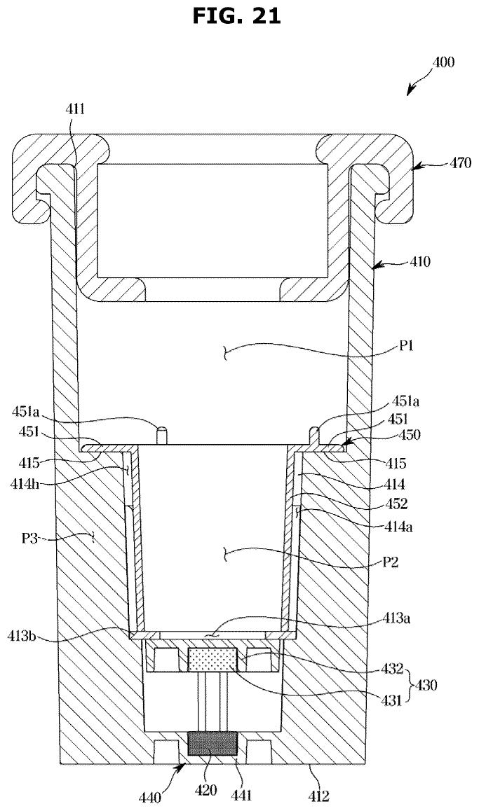

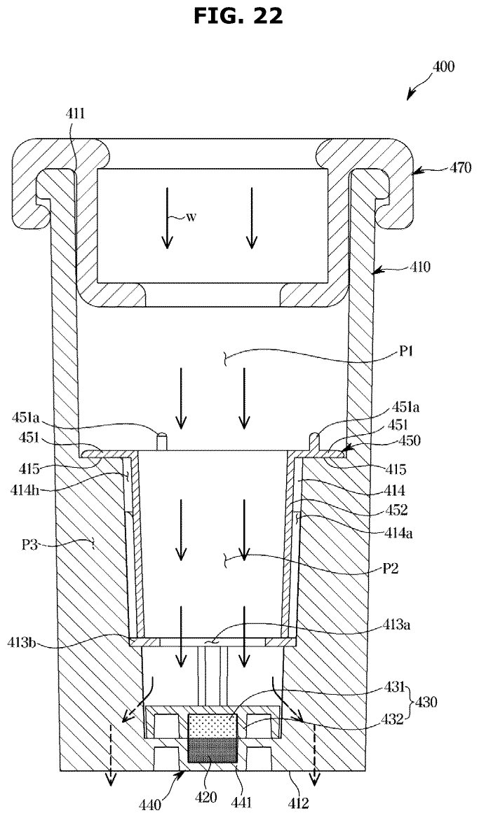

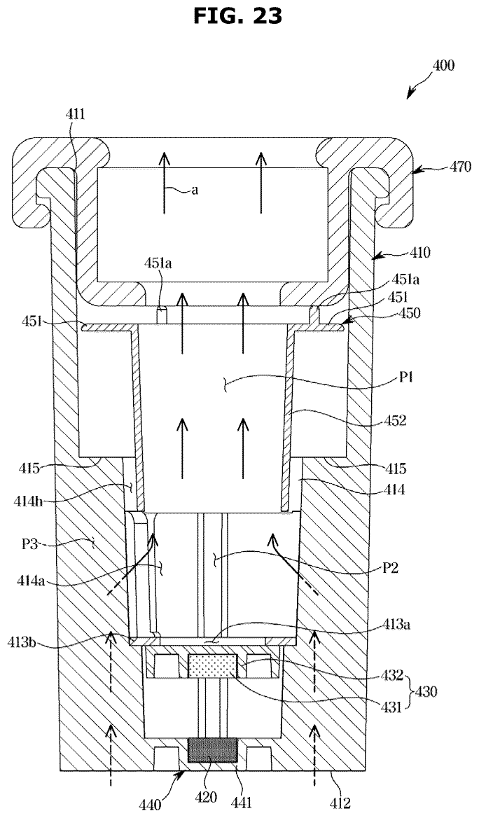

FIG. 19 is an exploded view illustrating components of a drain cap of the refrigerator according to an embodiment of the present disclosure. FIG. 20 is a cross-sectional perspective view illustrating that the drain cap of FIG. 19 is cut away in an assembled state. FIG. 21 is a cross-sectional view illustrating that the drain cap of FIG. 19 is cut away in the assembled state. FIG. 22 is a cross-sectional view illustrating that defrosted water is being drained in the state in which the drain cap of FIG. 19 is assembled. FIG. 23 is a cross-sectional view illustrating that air is being introduced from the machine room in the state in which the drain cap of FIG. 19 is assembled.

An arrow w in FIG. 22 indicates a drainage direction of defrosted water. An arrow a in FIG. 13 indicates an inflow direction of air.

Some components of the refrigerator 1 according to an embodiment of the present disclosure illustrated in FIGS. 19 to 23 corresponding to those in the embodiments illustrated in FIGS. 1 to 18 may be given the same reference numerals, and descriptions thereof may be omitted.

Referring to FIGS. 19 to 23, the refrigerator 1 according to an embodiment of the present disclosure may include the drain cap 400.

The drain cap 400 may include a cap body 410. The cap body 410 may be connected with the drain pipe 80. The cap body 410 may be connected with the discharge plug 90.

In this embodiment, the drain cap 400 may include a plug coupling member 470 provided to couple the discharge plug 90 to the cap body 410. The plug coupling member 470 may be coupled to an inlet 411 side of the cap body 410. The discharge plug 90 may be connected to the cap body 410 by being fitted into the plug coupling member 470.

As an example, the plug coupling member 470 may include various elastic materials such as rubber.

In addition, according to various embodiments, the drain cap 400 may include various structures for being coupled with the discharge plug 90.

The cap body 410 may include the inlet 411 provided to allow defrosted water to be introduced or air to be discharged, and an outlet 412 provided to allow defrosted water to be discharged or air to be introduced. The cap body 410 may have a flow path formed therein. The flow path of the cap body 410 may be provided such that defrosted water or air flows therethrough.

In detail, the cap body 410 may include a first flow path P1, a second flow path P2, and a third flow path P3. The first flow path P1 may extend from the inlet 411. The second flow path P2 may extend between the first flow path P1 and the outlet 412. The third flow path P3 may extend between the first flow path P1 and the outlet 412. For example, the second flow path P2 and the third flow path P3 may be partitioned from each other in a radial direction of the cap body 410.

The cap body 410 may include a partition 414 configured to partition the second flow path P2 and the third flow path P3. For example, the partition 414 may partition the second flow path P2 and the third flow path P3 in the radial direction. For example, the second flow path P2 may be provided inside the partition 414. For example, the third flow path P3 may be provided outside the partition 414.

The partition 414 may have a hollow shape of forming a flow path therein. The partition 414 may have a hollow shape of forming the second flow path P2 therein. The partition 414 may have a shape of surrounding the second flow path P2.

The partition 414 may include a partition hole 414a. The partition hole 414a may be formed along a circumference of the partition 414. As an example, a plurality of the partition holes 414a may be provided to be arranged to be spaced apart from each other along the circumference of the partition 414.

The partition hole 414a may be formed such that the inside and outside of partition 414 are connected. For example, the partition hole 414a may be formed such that the second flow path P2 and the third flow path P3 are connected therethrough. The second flow path P2 and the third flow path P3 partitioned by the partition 414 may be connected to each other through the partition hole 414a when an air valve 450 is ascended, as will be described later.

As an example, the partition hole 414a may extend from a lower end of the partition 414.

A drain flow path may be formed inside the cap body 410 such that defrosted water is drained therethrough. The first flow path P1 may form a portion of the drain flow path. The second flow path P2 may form another portion of the drain flow path.

An air flow path may be formed inside the cap body 410 such that air flows from the machine room RM toward the cooling chamber RC therethrough. The first flow path P1 may form a portion of the air flow path. The third flow path P3 may form another portion of the air flow path.

Portions of the drain flow path and air flow path may be partitioned from each other by the partition 414. The partition 414 may partition a portion of the drain flow path and a portion of the air flow path in the radial direction. For example, a portion of the drain flow path may be provided inside the partition 414. For example, a portion of the air flow path may be provided outside the partition 414.

A portion of the drain flow path and a portion of the air flow path may be connected to each other through the partition hole 414a when the air valve 450 is ascended. A lower portion of the drain flow path (e.g., a downstream portion of the drain flow path) and a lower portion of the air flow path (e.g., an upstream portion of the air flow path) may be connected to each other by the partition hole 414a when the air valve 450 is ascended.

The drain cap 400 may include a water valve 430 configured to open or close the drain flow path. The water valve 430 may be configured to be movable inside the cap body 410.

The water valve 430 may close the drain flow path in an ascended position as illustrated in FIG. 21. The water valve 430 may open the drain flow path in a descended position as illustrated in FIG. 22. The water valve 430 may be configured to be movable between the ascended position and the descended position.

For example, the cap body 410 may include a valve hole 413a. The valve hole 413a may be provided on the drain flow path. The drain flow path may pass through the valve hole 413a. When the valve hole 413a is opened, defrosted water may be allowed to flow and be drained along the drain flow path, and when the valve hole 413a is closed, defrosted water may be limited from being drained along the drain flow path. The water valve 430 may be configured to open and close the valve hole 413a. The water valve 430 may close the drain flow path by covering the valve hole 413a in the ascended position. The water valve 430 may open the drain flow path by being spaced apart from the valve hole 413a in the descended position.

The cap body 410 may include a valve hole forming portion 413b. The valve hole forming portion 413b may be provided along a circumference of the valve hole 413a. The valve hole forming portion 413b may be disposed above the water valve 430.

The water valve 430 may come into contact with the valve hole forming portion 413b in the ascended position. The water valve 430 that is moving toward the ascended position may stop and cover the valve hole 413a by coming into contact with the valve hole forming portion 413b.

In order to prevent the water valve 430 from further being ascended by passing through the valve hole 413a without being limited from being ascended by the valve hole forming portion 413b in the ascended position, a width (e.g., diameter) of the valve hole 413a may be smaller than a width of the water valve 430.

For ease of assembly of the water valve 430, the valve hole forming portion 413b may be provided as a configuration of being separable from other portion of the cap body 410. For example, the valve hole forming portion 413b may be provided as a configuration of being separable from the partition 414.

The valve hole 413a may be disposed on the second flow path P2. The second flow path P2 may pass through the valve hole forming portion 413b.

The valve hole 413a may be disposed on an inner side of the partition 414. The valve hole forming portion 413b may be disposed on the inner side of the partition 414.

The valve hole 413a may be provided at a lower portion of the partition 414. The valve hole forming portion 413b may be provided at the lower portion of the partition 414.

The water valve 430 may include a moving magnet 431. The drain cap 400 may include a fixed magnet 420 configured to be fixed to the cap body 410. The water valve 430 may be configured to be movable relative to the cap body 410 using a magnetic force between the moving magnet 431 and the fixed magnet 420.

The water valve 430 may include a water valve body 432 configured to support the moving magnet 431. Alternatively, the water valve 430 may not include the separate water valve body 432, and the entire water valve 430 may be configured as a magnetic body.

The water valve 430 may be ascended by the magnetic force between the fixed magnet 420 and the moving magnet 431. The water valve 430 may be located in the ascended position by the magnetic force between the fixed magnet 420 and the moving magnet 431. The water valve 430 may be configured to close the valve hole 413a and the drain flow path when ascended by the magnetic force between the fixed magnet 420 and the moving magnet 431.

For example, the water valve 430 may be configured to close the drain flow path by being ascended by a repulsive force between the moving magnet 431 and the fixed magnet 420. The moving magnet 431 may be disposed above the fixed magnet 420, and an upward magnetic force by the fixed magnet 420 may be applied to the moving magnet 431. Accordingly, the water valve 430 may be ascended or kept in the ascended position relative to the cap body 410.

The water valve 430 may be descended by defrosted water flowing along the drain flow path. The water valve 430 may be located in the descended position by defrosted water flowing along the drain flow path. The water valve 430 may be configured to open the valve hole 413a and the drain flow path when descended by defrosted water flowing along the drain flow path.

The drain cap 400 may include a magnet support 440 configured to support the fixed magnet 420. The magnet support 440 may fix the fixed magnet 420 to the cap body 410.

The magnet support 440 may include a magnet support portion 441 provided to support the fixed magnet 420. The fixed magnet 420 may be coupled to the magnet support portion 441.

The magnet support portion 441 may be disposed below the moving magnet 431. The magnet support portion 441 may be disposed below the water valve 430. The water valve 430 may come into contact with the magnet support portion 441 when reaching the descended position.

The magnet support 440 may be formed integrally with the cap body 410. The magnet support 440 may be defined as one component of the cap body 410. The magnet support 440 may be formed integrally with at least the valve hole forming portion 413b of the cap body 410.

The magnet support 440 may include a connecting portion 442 provided to connect the magnet support portion 441 and the cap body 410. The connecting portion 442 may connect the magnet support portion 441 and the valve hole forming portion 413b. The connecting portion 442 may extend substantially downward from the valve hole forming portion 413b toward the magnet support portion 441. As an example, the connecting portion 442 may extend in a vertical direction between the magnet support portion 441 and the valve hole forming portion 413b.

The magnet support 440 may be formed such that defrosted water may pass therethrough. The magnet support 440 may be formed such that water may pass therethrough in at least an area between the valve hole 413a and the magnet support portion 441. For example, the magnet support 440 may include a plurality of the connecting portions 442 spaced apart from each other, and defrosted water may pass between the plurality of connecting portions 442.

The magnet support 440 may be configured to guide a movement of the water valve 430. For example, the connecting portion 442 may guide the movement of the water valve 430. The connecting portion 442 may guide the movement of the water valve 430 by being in contact with an outer circumferential surface of the water valve 430. In detail, the plurality of connecting portions 442 may guide the movement of the water valve 430 by being disposed to surround the outer circumferential surface of the water valve 430. The water valve 430 may be movable in a direction parallel to a direction in which the connecting portion 442 extends. In this respect, the connecting portion 442 may also be referred to as the “movement guide 442.”

In various embodiments, the structure of fixing the fixed magnet 420 to the cap body 410 is not limited to that described above, and the fixed magnet 420 may be fixed to the cap body 410 by various structures.

The drain cap 400 may include the air valve 450 configured to open or close the air flow path. The air valve 450 may be disposed inside the cap body 410. The air valve 450 may be configured to be movable relative to the cap body 410.

The air valve 450 may close the air flow path in the descended position as illustrated in FIG. 21. The air valve 450 may open the air flow path in the ascended position as illustrated in FIG. 23. The air valve 450 may be configured to be movable between the descended position and the ascended position.

For example, a connecting hole 414h may be provided inside the cap body 410. The connecting hole 414h may connect the first flow path P1 and the third flow path P3. As an example, the connecting hole 414h may be formed between an upper portion of the partition 414 and an air valve support portion 415.

The air valve 450 may be configured to open and close the connecting hole 414h. The air valve 450 may close the connecting hole 414h in the descended position. The air valve 450 may close the air flow path by covering the connecting hole 414h in the descended position. The air valve 450 may open the connecting hole 414h in the ascended position. The air valve 450 may open the air flow path by being spaced apart from the connecting hole 414h in the ascended position.

The air valve 450 may be configured to be located in the descended position or to be descended from the ascended position, by a self-weight of the air valve 450. The air valve 450 may be configured to be ascended to the ascended position by the air pressure directing to the cooling chamber RC from the machine room RM.

The air valve 450 may include a cover portion 451. When the air valve 450 is located in the descended position, the cover portion 451 may be supported by the cap body 410. When the air valve 450 is located in the descended position, the cover portion 451 may come into contact with the air valve support portion 415 of the cap body 410.

The cover portion 451 may cover the air flow path from above when the air valve 450 is located in the descended position. When the air valve 450 is ascended relative to the cap body 410, the cover portion 451 may be spaced apart from the air valve support portion 415 upward. At this time, the connecting hole 414h may be opened and the air flow path may be opened, so that air may flow from the third flow path P3 toward the first flow path P1.

The air valve 450 may be not ascended further than the ascended position, for example, by being limited from being ascended by the plug coupling member 470 when ascended by air pressure. When the air valve 450 is located in the ascended position, the cover portion 451 may come into contact with a lower end of the plug coupling member 470. As an example, one or more protrusions 451a protruding upward may be provided on an upper surface of the cover portion 451, and when the protrusions 451a come into contact with the plug coupling member 470, the ascending of the air valve 450 may be stopped.

The air valve 450 may include a hollow forming portion 452. The hollow forming portion 452 may have a hollow formed therein. For example, the second flow path P2 may be formed inside the hollow forming portion 452. The drain flow path may penetrate the inside of the hollow forming portion 452.

When the air valve 450 is located in the descended position, the hollow forming portion 452 may be disposed inside the partition 414.

Unlike the hollow forming portions 152, 252, and 352 in the previous embodiments, the hollow forming portion 452 according to this embodiment may not have a hole formed on a circumference thereof. The hollow forming portion 452 may be partitioned into the inside and outside thereof. Accordingly, when the air valve 450 is located in the descended position as illustrated in FIG. 21, the hollow forming portion 452 may cover the partition hole 414a, and the second flow path P2 and the third flow path P3 may be partitioned from each other by the hollow forming portion 452.

As illustrated in FIG. 21, because both the connecting hole 414h and the partition hole 414a are covered when the air valve 450 is located in the descended position, air in the machine room RM may not be introduced into the first flow path P1 through the third flow path P3.

As illustrated in FIG. 23, when the air valve 450 is ascended, air in the machine room RM may be introduced into the first flow path P1 through the outlet 412, the third flow path P3, the partition hole 414a, and the connecting hole 414h, and may flow upward along an inner space of the hollow forming portion 452 through the air flow hole 452h. Accordingly, air may flow into the cooling chamber RC through the inlet 411.

Hereinafter, the flow of defrosted water or air in the drain cap 400 according to an embodiment of the present disclosure will be described with reference to FIGS. 21 to 23.

As illustrated in FIG. 21, when defrosted water is not drained, the water valve 430 may cover the valve hole 413a by being ascended by the repulsive force between the fixed magnet 420 and the moving magnet 431, and the drain flow path may be closed. In addition, when the air pressure directing to the cooling chamber RC from the machine room RM is not sufficiently high, the air valve 450 may cover the partition hole 414a and the connecting hole 414h by being descended by the self-weight, and the air flow path may be closed.

As illustrated in FIG. 22, when defrosted water is introduced into the drain cap 400 from the evaporator 50, the water valve 430 may be pushed down and descended by the defrosted water, and the drain flow path may be opened as the valve hole 413a is opened. The defrosted water passed through the valve hole 413a may be drained into the machine room RM through the outlet 412.

As illustrated in FIG. 23, when the air pressure directing to the cooling chamber RC from the machine room RM is high enough to ascend the air valve 450 (e.g., when the door 30 is opened), the air valve 450 may be pushed upward and ascended by the air pressure, and the air flow path may be opened as the connecting hole 414h is opened. Air in the machine room RM may be introduced into the third flow path P3 through the outlet 412, sequentially pass through the third flow path P3, the partition hole 414a, the connecting hole 414h, and the air flow hole 452h, and then move to the cooling chamber RC side through the inlet 411.

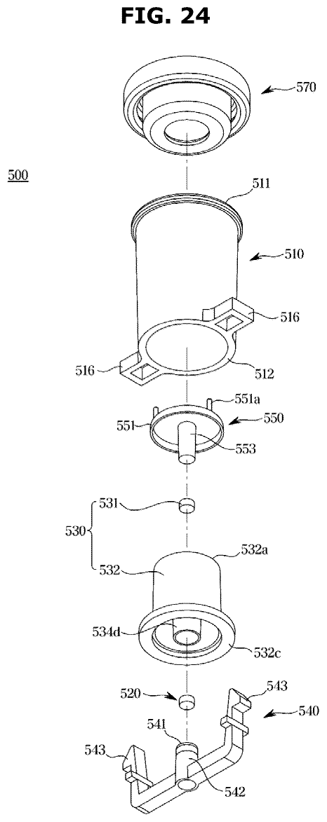

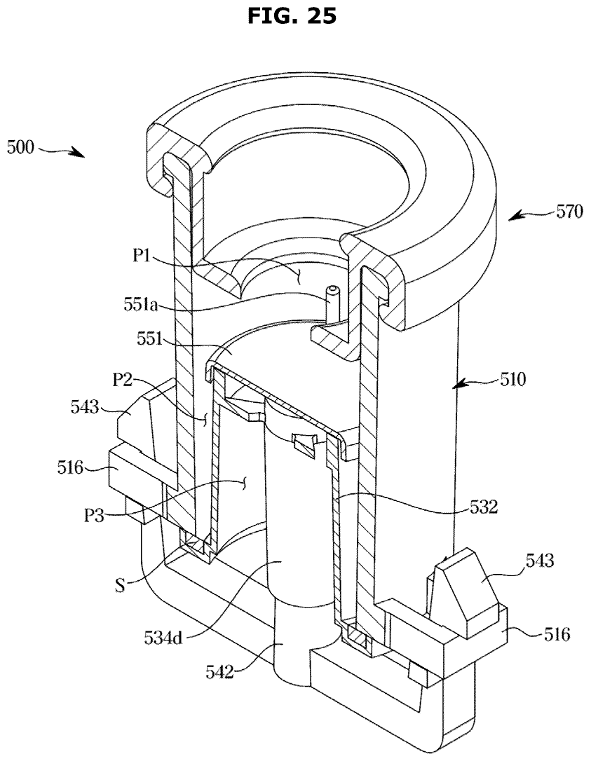

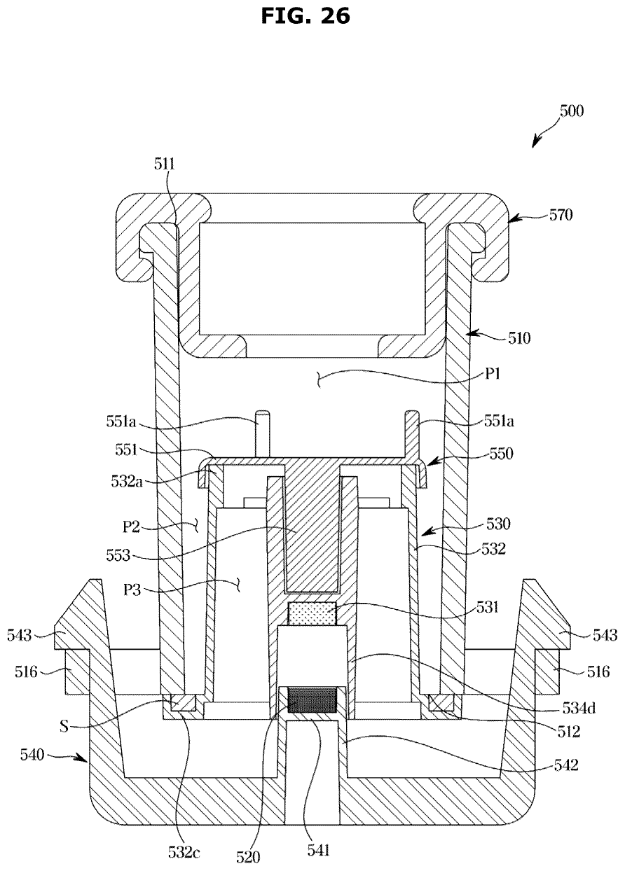

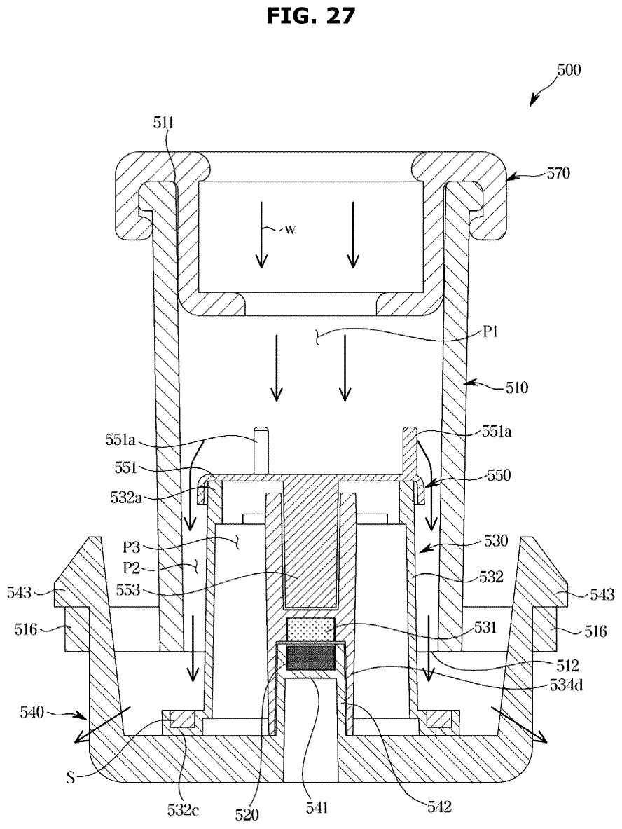

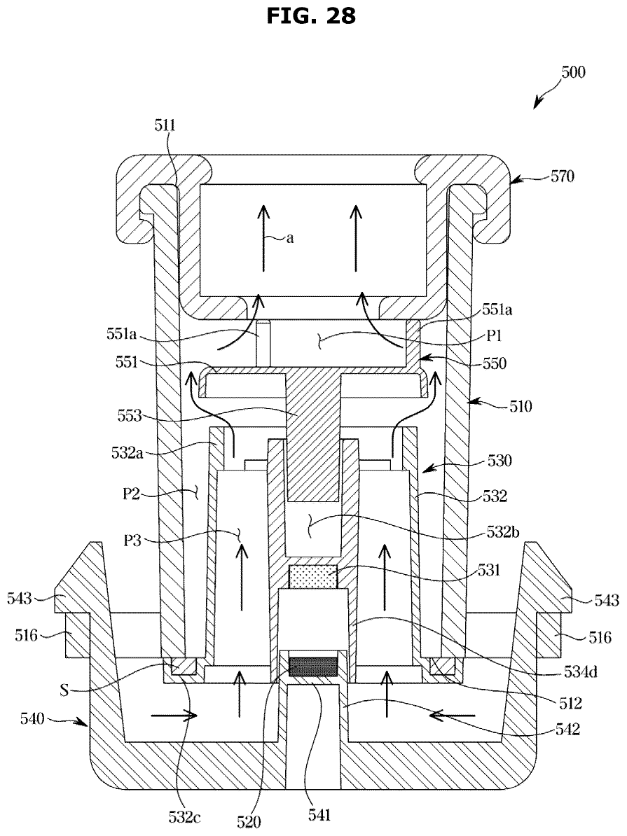

FIG. 24 is an exploded view illustrating components of a drain cap of the refrigerator according to an embodiment of the present disclosure. FIG. 25 is a cross-sectional perspective view illustrating that the drain cap of FIG. 24 is cut away in an assembled state. FIG. 26 is a cross-sectional view illustrating that the drain cap of FIG. 24 is cut away in the assembled state. FIG. 27 is a cross-sectional view illustrating that defrosted water is being drained in the state in which the drain cap of FIG. 24 is assembled. FIG. 28 is a cross-sectional view illustrating that air is being introduced from the machine room in the state in which the drain cap of FIG. 24 is assembled.

An arrow w in FIG. 27 indicates a drainage direction of defrosted water. An arrow a in FIG. 28 indicates an inflow direction of air.

Some components of the refrigerator 1 according to an embodiment of the present disclosure illustrated in FIGS. 24 to 29 corresponding to those in the embodiments illustrated in FIGS. 1 to 23 may be given the same reference numerals, and descriptions thereof may be omitted.

Referring to FIGS. 24 to 29, the refrigerator 1 according to an embodiment of the present disclosure may include the drain cap 500.

The drain cap 500 may include a cap body 510. The cap body 510 may be connected with the drain pipe 80. The cap body 510 may be connected with the discharge plug 90.

In this embodiment, the drain cap 500 may include a plug coupling member 570 provided to couple the discharge plug 90 to the cap body 510. The plug coupling member 570 may be coupled to an inlet 511 side of the cap body 510. The discharge plug 90 may be connected to the cap body 510 by being fitted into the plug coupling member 570.

As an example, the plug coupling member 570 may include various elastic materials such as rubber.

In addition, according to various embodiments, the drain cap 500 may include various structures for being coupled with the discharge plug 90.

The cap body 510 may include the inlet 511 provided to allow defrosted water to be introduced or air to be discharged, and an outlet 512 provided to allow defrosted water to be discharged or air to be introduced. The cap body 410 may have a flow path formed therein. The flow path of the cap body 510 may be provided such that defrosted water or air flows therethrough.

In detail, the cap body 510 may include a first flow path P1, a second flow path P2, and a third flow path P3. The first flow path P1 may extend from the inlet 511. The second flow path P2 may extend between the first flow path P1 and the outlet 512. The third flow path P3 may extend between the first flow path P1 and the outlet 512. For example, the second flow path P2 and the third flow path P3 may be partitioned from each other in a radial direction of the cap body 510.

For example, the second flow path P2 and the third flow path P3 may be partitioned by a water valve 530. The second flow path P2 and the third flow path P3 may be partitioned by an outer circumferential surface of a water valve body 532. For example, the third flow path P3 may be provided inside the water valve body 532. For example, the second flow path P2 may be provided outside the water valve body 532.

A drain flow path may be formed inside the cap body 510 such that defrosted water is drained therethrough. The first flow path P1 may form a portion of the drain flow path. The second flow path P2 may form another portion of the drain flow path.

An air flow path may be formed inside the cap body 510 such that air flows from the machine room RM toward the cooling chamber RC therethrough. The first flow path P1 may form a portion of the air flow path. The third flow path P3 may form another portion of the air flow path.

Portions of the drain flow path and air flow path may be partitioned from each other by an outer circumference of the water valve body 532. The water valve body 532 may partition a portion of the drain flow path and a portion of the air flow path in the radial direction. For example, a portion of the drain flow path may be provided outside the water valve body 532. For example, a portion of the air flow path may be provided inside the water valve body 532.

The drain cap 500 may include a water valve 530 configured to open or close the drain flow path. The water valve 530 may be configured to be movable inside the cap body 510.

The water valve 530 may close the drain flow path in an ascended position as illustrated in FIG. 26. The water valve 530 may open the drain flow path in a descended position as illustrated in FIG. 27. The water valve 530 may be configured to be movable between the ascended position and the descended position.

The water valve 530 may include a moving magnet 531. The drain cap 500 may include a fixed magnet 520 configured to be fixed to the cap body 510. The water valve 530 may be configured to be movable relative to the cap body 510 using a magnetic force between the moving magnet 531 and the fixed magnet 520.

The water valve 530 may be ascended by the magnetic force between the fixed magnet 520 and the moving magnet 531. The water valve 530 may be located in the ascended position by the magnetic force between the fixed magnet 520 and the moving magnet 531. The water valve 530 may be configured to close the drain flow path when ascended by the magnetic force between the fixed magnet 520 and the moving magnet 531.

For example, the water valve 530 may be configured to close the drain flow path by being ascended by a repulsive force between the moving magnet 531 and the fixed magnet 520. The moving magnet 531 may be disposed above the fixed magnet 520, and an upward magnetic force by the fixed magnet 520 may be applied to the moving magnet 531. Accordingly, the water valve 530 may be ascended or kept in the ascended position relative to the cap body 510.

The water valve 530 may be descended by defrosted water flowing along the drain flow path. The water valve 530 may be located in the descended position by defrosted water flowing along the drain flow path. The water valve 530 may be configured to open the drain flow path when descended by defrosted water flowing along the drain flow path. For example, defrosted water flowing along the drain flow path may push down a drain flow path cover portion 532c of the water valve 530, which will be described later, to descend the water valve 530.

The water valve 530 may include the water valve body 532 configured to support the moving magnet 531. The moving magnet 531 may be coupled to the water valve body 532. As an example, the moving magnet 531 may be disposed substantially at a center of the water valve body 532. As an example, the moving magnet 531 may be disposed on an upper side of a guide portion 534d of the water valve body 532, which will be described later. As an example, the moving magnet 531 may be disposed on an upper side of an air valve groove 532b of the water valve body 532, which will be described later.

For example, the water valve 530 may close the drain flow path by covering the outlet 512 of the cap body 510 in the ascended position. The water valve 530 may open the drain flow path by being spaced apart from the outlet 512 in the descended position. Specifically, the water valve body 532 may cover the outlet 512 in the ascended position and may be spaced apart from the outlet 512 in the descended position. The outlet 512 of the cap body 510 may also be referred to as “valve hole 512” which is opened and closed by the water valve 530.

The water valve body 532 may include a drain flow path cover portion 532c configured to close the drain flow path by covering the outlet 512 in the ascended position. As an example, the drain flow path cover portion 532c may be provided at a lower end of the water valve body 532. As an example, the drain flow path cover portion 532c may be provided on an outer circumferential portion of the lower end of the water valve body 532.

A sealing member S may be provided on the drain flow path cover portion 532c to seal a gap between the drain flow path cover portion 532c and the outlet 512 in the ascended position. The sealing member S may include various elastic materials such as rubber.

As an example, the water valve body 532 may have a substantially cylindrical shape with a hollow space formed therein. The third flow path P3 may be disposed inside the water valve body 532. The air flow path may pass through the water valve body 532. The water valve body 532 may be configured to have lower and upper ends open, respectively, such that air may pass therethrough.

The drain cap 500 may include a magnet support 540 configured to support the fixed magnet 520. The magnet support 540 may fix the fixed magnet 520 to the cap body 510.

As an example, the magnet support 540 may be disposed on an outer side of the cap body 510. As an example, the magnet support 540 may be disposed on an outer lower side of the cap body 510.

The magnet support 540 may include a magnet support portion 541 provided to support the fixed magnet 520. The fixed magnet 520 may be coupled to the magnet support portion 541.

The magnet support portion 541 may be disposed below the moving magnet 531. The magnet support portion 541 may be disposed below the water valve 530. The water valve 530 may come into contact with the magnet support portion 541 when reaching the descended position.

The magnet support 540 may include a fixed portion 543 provided to be fixed to the cap body 510. The fixed portion 543 may be coupled to the cap body 510. The cap body 510 may include a supporter fixing portion 516, and the fixed portion 543 may be coupled to the supporter fixing portion 516. As an example, the fixed portion 543 has a hook shape to be caught on and coupled to the support fixing portion 516.

The magnet support 540 may include a connecting portion 542 provided to connect the magnet support portion 541 and the fixed portion 543. The connecting portion 542 may support the magnet support portion 541 with respect to the fixed portion 543. The connecting portion 542 may extend substantially downward from the magnet support portion 541. The connecting portion 542 may extend substantially in a vertical direction.

The magnet support 540 may be configured to guide a movement of the water valve 530. For example, the connecting portion 542 may guide the movement of the water valve 530. The water valve 530 may include the guide portion 534d. The guide portion 534d may have a groove formed therein. When the water valve 530 is descended, the magnet support portion 541, connecting portion 542, etc. of the magnet support 540 may be inserted into the groove of the guide portion 534d. When the connecting portion 542 is inserted into the groove of guide portion 534d, the connecting portion 542 may come into contact with an inner surface of the guide portion 534d, and a movement of the guide portion 534d may be guided by the connecting portion 542. The water valve 530 may be movable in a direction parallel to a direction in which the connecting portion 542 extends. In this respect, the connecting portion 542 may also be referred to as the “movement guide 542.”

In various embodiments, the structure of fixing the fixed magnet 520 to the cap body 510 is not limited to that described above, and the fixed magnet 520 may be fixed to the cap body 510 by various structures.

The drain cap 500 may include an air valve 550 configured to open or close the air flow path. The air valve 550 may be disposed inside the cap body 510. The air valve 550 may be configured to be movable relative to the cap body 510.

The air valve 550 may close the air flow path in the descended position as illustrated in FIG. 26. The air valve 550 may open the air flow path in the ascended position as illustrated in FIG. 28. The air valve 550 may be configured to be movable between the descended position and the ascended position.

The air valve 550 may be configured to be located in the descended position or to be descended from the ascended position, by a self-weight of the air valve 550. The air valve 550 may be configured to be ascended to the ascended position by the air pressure directing to the cooling chamber RC from the machine room RM.

For example, the air valve 550 may close the air flow path by covering an opening formed at an upper end of the water valve body 532 in the descended position. The air valve 550 may open the air flow path by being spaced apart from the opening formed at the upper end of the water valve body 532 in the ascended position.

The air valve 550 may include a cover portion 551. When the air valve 550 is located in the descended position, the cover portion 551 may be supported by the water valve body 532. An air valve support portion 532a may be provided on the upper end of the water valve body 532 to support the air valve 550.

When the air valve 550 is located in the descended position, the cover portion 551 may come into contact with the air valve support portion 532a and cover the opening at the upper end of the water valve body 532, and may close the air flow path. When the air valve 550 is ascended relative to the cap body 510, the cover portion 551 may be spaced apart from the air valve support portion 532a upward. At this time, the opening at the upper end of the water valve body 532 may be opened and the air flow path may be opened, so that air may flow from the third flow path P3 toward the first flow path P1.

As an example, a width of the cover portion 551 may be larger than or at least equal to a width of the opening at the upper end of the water valve body 532.

The air valve 550 may be not ascended further than the ascended position, for example, by being limited from being ascended by the plug coupling member 570 when ascended by air pressure. When the air valve 550 is located in the ascended position, the cover portion 551 may come into contact with a lower end of the plug coupling member 570. As an example, one or more protrusions 551a protruding upward may be provided on an upper surface of the cover portion 551, and when the protrusions 551a come into contact with the plug coupling member 570, the ascending of the air valve 550 may be stopped.

A movement of the air valve 550 between the descended position and the ascended position may be guided by the water valve body 532. For example, the air valve groove 532b may be formed on the water valve body 532, and the air valve 550 may include an insertion portion 553 provided to be movable relative to the air valve groove 532b. The insertion portion 553 may protrude downward from the cover portion 551, and the air valve groove 532b may have a shape of being concavely recessed downward. When the air valve 550 is descended, the insert portion 553 may be inserted into the air valve groove 532b, and when the air valve 550 is ascended, the insert portion 553 may be withdrawn from the air valve groove 532b. The air valve groove 532b may support the air valve 550 and guide the movement of the air valve 550, through the insertion portion 553.

Hereinafter, the flow of defrosted water or air in the drain cap 500 according to an embodiment of the present disclosure will be described with reference to FIGS. 26 to 28.

As illustrated in FIG. 26, when defrosted water is not drained, the water valve 530 may cover the outlet 512 of the cap body 510 by being ascended by the repulsive force between the fixed magnet 520 and the moving magnet 531, and the drain flow path may be closed. In addition, when the air pressure directing to the cooling chamber RC from the machine room RM is not sufficiently high, the air valve 550 may cover the opening at the upper end of the water valve body 532 by being descended by the self-weight, and the air flow path may be closed.

As illustrated in FIG. 27, when defrosted water is introduced into the drain cap 500 from the evaporator 50, the water valve 530 may be pushed down and descended by the defrosted water, and the drain flow path may be opened as the outlet 512 is opened. The defrosted water passed through the valve hole 413a may be drained into the machine room RM through the outlet 512.

As illustrated in FIG. 28, when the air pressure directing to the cooling chamber RC from the machine room RM is high enough to ascend the air valve 550 (e.g., when the door 30 is opened), the air valve 550 may be pushed upward and ascended by the air pressure, and the air flow path may be opened as the upper end of the water valve body 532 is opened. Air in the machine room RM may be introduced into the third flow path P3 through the outlet 512, sequentially pass through the third flow path P3, the opening at the upper end of the water valve body 532, and the first flow path P1, and then move to the cooling chamber RC side through the inlet 511.

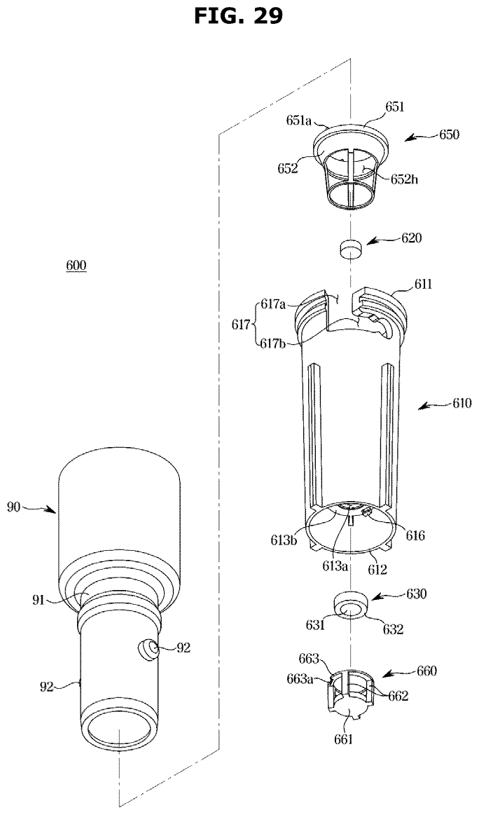

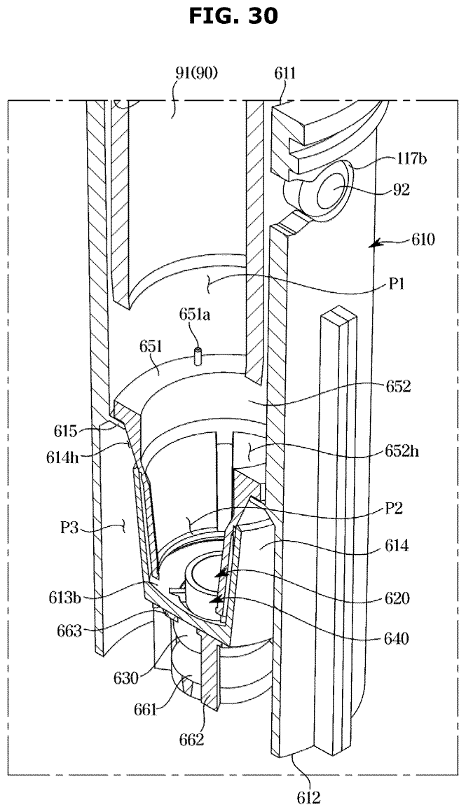

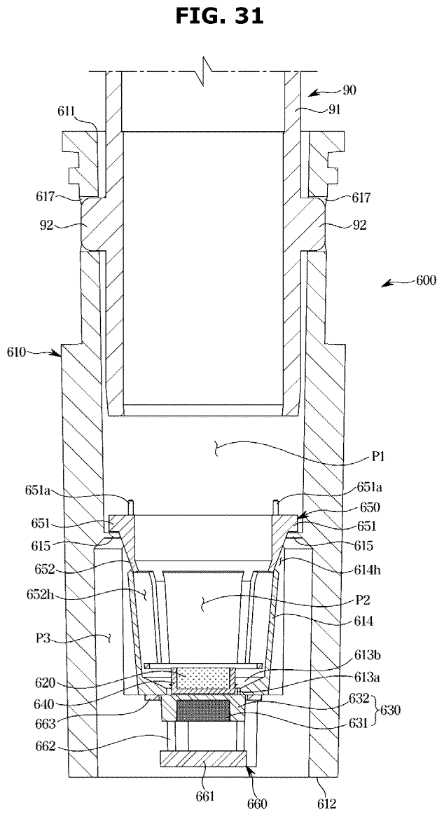

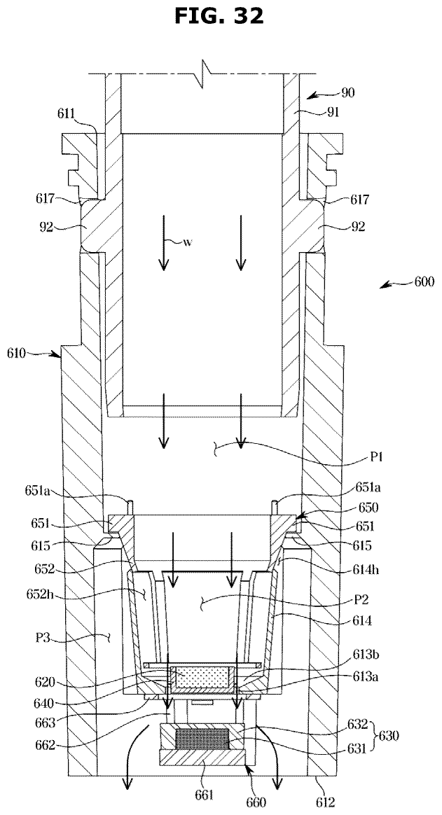

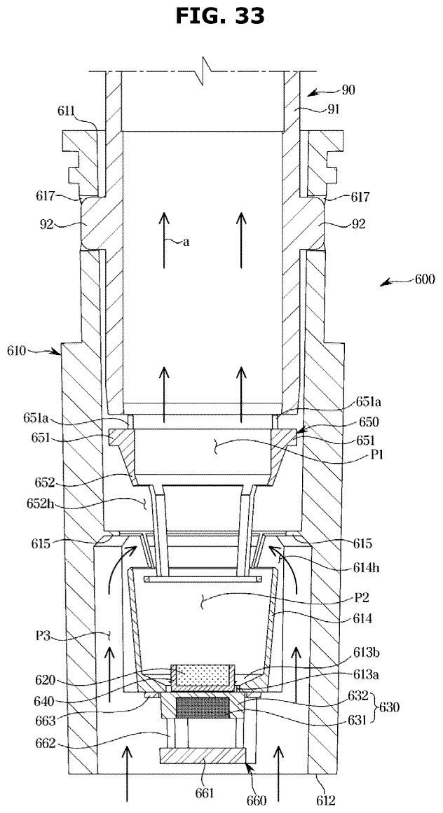

FIG. 29 is an exploded view illustrating the discharge plug and components of a drain cap of the refrigerator according to an embodiment of the present disclosure. FIG. 30 is a cross-sectional perspective view illustrating that the discharge plug and drain cap of FIG. 29 are cut away in an assembled state. FIG. 31 is a cross-sectional view illustrating that the discharge plug and drain cap of FIG. 29 are cut away in the assembled state. FIG. 32 is a cross-sectional view illustrating that defrosted water is being drained in the state in which the discharge plug and drain cap of FIG. 29 are assembled. FIG. 33 is a cross-sectional view illustrating that air is being introduced from the machine room in the state in which the discharge plug and drain cap of FIG. 29 are assembled.

An arrow w in FIG. 32 indicates a drainage direction of defrosted water. An arrow a in FIG. 33 indicates an inflow direction of air.

Some components of the refrigerator 1 according to an embodiment of the present disclosure illustrated in FIGS. 29 to 33 corresponding to those in the embodiments illustrated in FIGS. 1 to 28 may be given the same reference numerals, and descriptions thereof may be omitted.

Referring to FIGS. 29 to 33, the refrigerator 1 according to an embodiment of the present disclosure may include the drain cap 600.

The drain cap 600 may include a cap body 610. The cap body 610 may be connected with the drain pipe 80. The cap body 610 may be connected with the discharge plug 90.

The cap body 610 may be coupled with the discharge plug 90. For example, the cap body 610 may include a plug coupling portion 617 provided to be coupled to the discharge plug 90. The discharge plug 90 and the cap body 610 may be coupled to each other as a coupling protrusion 92 penetrates the plug coupling portion 617 and is caught thereon.

The plug coupling portion 617 may include an insertion portion 617a extending along a longitudinal direction (or an axial direction) of the cap body 610, and a coupling portion 617b extending from the insertion portion 617a along a direction different from the longitudinal direction of the cap body 610 (e.g., a circumferential direction of the cap body 610). A process of coupling or separating the discharge plug 90 and the cap body 610 using a structure of the plug coupling portion 617 and the coupling protrusion 92 is the same as in the embodiments described above with reference to FIGS. 3 to 13, and therefore a detailed description thereof will be omitted.

In addition, according to various embodiments, the drain cap 600 may include various structures for being coupled with the discharge plug 90.

The cap body 610 may include an inlet 611 provided to allow defrosted water to be introduced or air to be discharged, and an outlet 612 provided to allow defrosted water to be discharged or air to be introduced. The cap body 610 may have a flow path formed therein. The flow path of the cap body 610 may be provided such that defrosted water or air flows therethrough.

In detail, the cap body 610 may include a first flow path P1, a second flow path P2, and a third flow path P3. The first flow path P1 may extend from the inlet 611. The second flow path P2 may extend between the first flow path P1 and the outlet 612. The third flow path P3 may extend between the first flow path P1 and the outlet 612. For example, the second flow path P2 and the third flow path P3 may be partitioned from each other in a radial direction of the cap body 610.

The cap body 610 may include a partition 614 configured to partition the second flow path P2 and the third flow path P3. For example, the partition 614 may partition the second flow path P2 and the third flow path P3 in the radial direction. For example, the second flow path P2 may be provided inside the partition 614. For example, the third flow path P3 may be provided outside the partition 614.

The partition 614 may have a hollow shape of forming a flow path therein. The partition 614 may have a hollow shape of forming the second flow path P2 therein. The partition 614 may have a shape of surrounding the second flow path P2.

A drain flow path may be formed inside the cap body 610 such that defrosted water is drained therethrough. The first flow path P1 may form a portion of the drain flow path. The second flow path P2 may form another portion of the drain flow path.

An air flow path may be formed inside the cap body 610 such that air flows from the machine room RM toward the cooling chamber RC therethrough. The first flow path P1 may form a portion of the air flow path. The third flow path P3 may form another portion of the air flow path.

Portions of the drain flow path and air flow path may be partitioned from each other by the partition 614. The partition 614 may partition a portion of the drain flow path and a portion of the air flow path in the radial direction. For example, a portion of the drain flow path may be provided inside the partition 614. For example, a portion of the air flow path may be provided outside the partition 614.

The drain cap 600 may include a water valve 630 configured to open or close the drain flow path. The water valve 630 may be configured to be movable inside the cap body 610.

The water valve 630 may close the drain flow path in an ascended position as illustrated in FIG. 31. The water valve 630 may open the drain flow path in a descended position as illustrated in FIG. 32. The water valve 630 may be configured to be movable between the ascended position and the descended position.

For example, the cap body 610 may include a valve hole 613a. The valve hole 613a may be provided on the drain flow path. The drain flow path may pass through the valve hole 613a. When the valve hole 613a is opened, defrosted water may be allowed to flow and be drained along the drain flow path, and when the valve hole 613a is closed, defrosted water may be limited from being drained along the drain flow path. The water valve 630 may be configured to open and close the valve hole 613a.

The water valve 630 may close the drain flow path by covering the valve hole 613a in the ascended position. The water valve 630 may open the drain flow path by being spaced apart from the valve hole 613a in the descended position.

The cap body 610 may include a valve hole forming portion 613b. The valve hole forming portion 613b may be provided along a circumference of the valve hole 613a. The valve hole forming portion 613b may be disposed above the water valve 630.

The water valve 630 may come into contact with the valve hole forming portion 613b in the ascended position. The water valve 630 that is moving toward the ascended position may stop and cover the valve hole 613a by coming into contact with the valve hole forming portion 613b.

In order to prevent the water valve 630 from further being ascended by passing through the valve hole 613a without being limited from being ascended by the valve hole forming portion 613b in the ascended position, a width (e.g., diameter) of the valve hole 613a may be smaller than a width of the water valve 630.

The valve hole 613a may be disposed on the second flow path P2. The second flow path P2 may pass through the valve hole forming portion 613b.

The valve hole 613a may be disposed on an inner side of the partition 614. The valve hole forming portion 613b may be disposed on the inner side of the partition 614.

The valve hole 613a may be provided at a lower portion of the partition 614. The valve hole forming portion 613b may be provided at the lower portion of the partition 614.

The water valve 630 may include a moving magnet 631. The drain cap 600 may include a fixed magnet 620 configured to be fixed to the cap body 610. The water valve 630 may be configured to be movable relative to the cap body 610 using a magnetic force between the moving magnet 631 and the fixed magnet 620.

The water valve 630 may include a water valve body 632 configured to support the moving magnet 631. Alternatively, the water valve 630 may not include the separate water valve body 632, and the entire water valve 630 may be configured as a magnetic body.

The water valve 630 may be ascended by the magnetic force between the fixed magnet 620 and the moving magnet 631. The water valve 630 may be located in the ascended position by the magnetic force between the fixed magnet 620 and the moving magnet 631. The water valve 630 may be configured to close the valve hole 613a and the drain flow path when ascended by the magnetic force between the fixed magnet 620 and the moving magnet 631.

For example, the water valve 630 may be configured to close the drain flow path by being ascended by an attractive force between the moving magnet 631 and the fixed magnet 620. The moving magnet 631 may be disposed below the fixed magnet 620, and the magnetic force pulling upward toward the fixed magnet 620 may be applied to the moving magnet 631. Accordingly, the water valve 630 may be ascended or kept in the ascended position relative to the cap body 610.

The water valve 630 may be descended by defrosted water flowing along the drain flow path. The water valve 630 may be located in the descended position by defrosted water flowing along the drain flow path. The water valve 630 may be configured to open the valve hole 613a and the drain flow path when descended by defrosted water flowing along the drain flow path.

The drain cap 600 may include a magnet support 640 configured to support the fixed magnet 620. The magnet support 640 may fix the fixed magnet 620 to the cap body 610. The fixed magnet 620 may be coupled to the magnet support 640. The magnet support 640 may be disposed on the moving magnet 631. The magnet support 640 may be disposed on an upper side of the valve hole 613a. As an example, the magnet support 640 may be disposed in a center of the valve hole forming portion 613b. As an example, the magnet support 640 may be connected with the valve hole forming portion 613b, and further may be formed integrally with the valve hole forming portion 613b. As an example, the magnet support 640 may be disposed in the second flow path P2 inside the partition 614.

A width of each of the magnet support 640 and the fixed magnet 620 may be smaller than a width of the valve hole 613a. Accordingly, defrosted water, which is draining along the second flow path P2, may be drained through the valve hole 613a without being blocked by the magnet support 640 and the fixed magnet 620.

The drain cap 600 may further include a valve guide 660 configured to guide a position of the water valve 630. The valve guide 660 may guide the descended position of the water valve 630. The valve guide 660 may guide the ascending or descending of the water valve 630.

As an example, the valve guide 660 may be disposed on the drain flow path. As an example, the valve guide 660 may be disposed on the second flow path P2.

The valve guide 660 may include a valve limiting part 661 configured to guide the descended position of the water valve 630. The valve limiting part 661 may be provided at a lower end of the valve guide 660. The valve limiting part 661 may support the water valve 630 located in the descended position, and prevent the water valve 630 from being further descended or deviated from the descended position.

As an example, the valve limiting part 661 may be arranged parallel to the valve hole 613a in a vertical direction. As an example, the valve limiting part 661 may be arranged parallel to the valve hole forming portion 613b in the vertical direction. The water valve 630 may be movable between the valve hole 613a, the valve hole forming portion 613b, and the valve limiting part 661.

The valve guide 660 may include a fixed portion 663 provided to be fixed to the cap body 610. The fixed portion 663 may be coupled to the cap body 610. The cap body 610 may include a guide fixing portion 616, and the fixed portion 663 may be coupled to the guide fixing portion 616. As an example, the fixed portion 663 may be coupled to the valve hole forming portion 613b, and the guide fixing portion 616 may be provided on the valve hole forming portion 613b. In detail, the fixed portion 663 may be coupled to a lower side of the valve hole forming portion 613b.

The valve guide 660 may be coupled to or separated from the guide fixing portion 616 by the fixed portion 663. For example, the fixed portion 663 may include a fixed portion hole 663a. A process of coupling or separating the valve guide 660 to or from the guide fixing portion 616 using the fixed portion 663 including the fixed portion hole 663a corresponds to the process of coupling or separating the magnet support 140 to or from the supporter fixing portion 116 using the fixed portion 143 including the fixed portion hole 143a described with reference to FIG. 8, and therefore a detailed description thereof will be omitted.

The valve guide 660 may include a connecting portion 662 provided to connect the valve limiting part 661 and the fixed portion 663. The connecting portion 662 may support the valve limiting part 661 with respect to the fixed portion 663. The connecting portion 662 may extend substantially downward from the fixed portion 663 toward the valve limiting part 661. As an example, the connecting portion 662 may extend in the vertical direction between the valve limiting part 661 and the fixed portion 663.

The valve guide 660 may be formed such that defrosted water may pass therethrough. The valve guide 660 may be formed such that water may pass therethrough in at least an area between the fixed portion 663 and the valve limiting part 661. For example, the valve guide 660 may include a plurality of the connecting portions 662 spaced apart from each other, and defrosted water may pass between the plurality of connecting portions 662.

The connecting portions 662 may be configured to guide a movement of the water valve 630 between the ascended position and the descended position. For example, the connecting portion 662 may guide the movement of the water valve 630 by being in contact with an outer circumferential surface of the water valve 630. In detail, the plurality of connecting portions 662 may guide the movement of the water valve 630 by being disposed to surround the outer circumferential surface of the water valve 630. The water valve 630 may be movable in a direction parallel to a direction in which the connecting portion 662 extends. In this respect, the connecting portion 662 may also be referred to as the “movement guide 662.”

The drain cap 600 may include an air valve 650 configured to open or close the air flow path. The air valve 650 may be disposed inside the cap body 610. The air valve 650 may be configured to be movable relative to the cap body 610.

The air valve 650 may close the air flow path in the descended position as illustrated in FIG. 31. The air valve 650 may open the air flow path in the ascended position as illustrated in FIG. 33. The air valve 650 may be configured to be movable between the descended position and the ascended position.

For example, a connecting hole 614h may be provided inside the cap body 610. The connecting hole 614h may connect the first flow path P1 and the third flow path P3. As an example, the connecting hole 614h may be formed between an upper end of the partition 614 and an air valve support portion 615.

The air valve 650 may be configured to open and close the connecting hole 614h. The air valve 650 may close the connecting hole 614h in the descended position. The air valve 650 may close the air flow path by covering the connecting hole 614h in the descended position. The air valve 650 may open the connecting hole 614h in the ascended position. The air valve 650 may open the air flow path by being spaced apart from the connecting hole 614h in the ascended position.

The air valve 650 may be configured to be located in the descended position or to be descended from the ascended position, by a self-weight of the air valve 650. The air valve 650 may be configured to be ascended to the ascended position by the air pressure directing to the cooling chamber RC from the machine room RM.

The air valve 650 may include a cover portion 651. When the air valve 650 is located in the descended position, the cover portion 651 may be supported by the cap body 610. When the air valve 650 is located in the descended position, the cover portion 651 may come into contact with the air valve support portion 615 of the cap body 610.

The cover portion 651 may cover the air flow path from above when the air valve 650 is located in the descended position. When the air valve 650 is ascended relative to the cap body 610, the cover portion 651 may be spaced apart from the air valve support portion 615 upward. At this time, the connecting hole 614h may be opened and the air flow path may be opened, so that air may flow from the third flow path P3 toward the first flow path P1.

The air valve 650 may be not ascended further than the ascended position, for example, by being limited from being ascended by the discharge plug 90 when ascended by air pressure. When the air valve 650 is located in the ascended position, the cover portion 651 may come into contact with the lower end of the discharge plug 90. As an example, one or more protrusions 651a protruding upward may be provided on an upper surface of the cover portion 651, and when the protrusions 651a come into contact with the discharge plug 90, the ascending of the air valve 650 may be stopped.

The air valve 650 may include a hollow forming portion 652. The hollow forming portion 652 may have a hollow formed therein. For example, the second flow path P2 may be formed inside the hollow forming portion 652. The drain flow path may penetrate the inside of the hollow forming portion 652.

When the air valve 650 is located in the descended position, the hollow forming portion 652 may cover the connecting hole 614h. For example, when the air valve 650 is located in the descended position, the connecting hole 614h may be covered by an upper portion of the hollow forming portion 652. The upper portion of the hollow forming portion 652 covering the connecting hole 614h may be disposed above an air flow hole 652h.

Alternatively, when the air valve 650 is located in the descended position, the connecting hole 614h may be covered by the cover portion 651.

When the air valve 650 is located in the descended position, the hollow forming portion 652 may be disposed on an inner side of the partition 614.

The air flow hole 652h may be formed in the hollow forming portion 652. The air flow hole 652h may be provided such that air outside the air valve 650 may flow into the air valve 650 through the air flow hole 652h. The air flow hole 652h may be formed along a circumference of the hollow forming portion 652. One or more of the air flow holes 652h may be formed along the circumference of the hollow forming portion 652.

As illustrated in FIG. 31, when the air valve 650 is located in the descended position, the air flow hole 652h may be covered by the partition 614. Therefore, because both the connecting hole 614h and the air flow hole 652h are covered, air in the machine room RM may not be introduced into the first flow path P1 through the third flow path P3.

As illustrated in FIG. 33, when the air valve 650 is ascended, air in the machine room RM may be introduced into the first flow path P1 through the outlet 612, the third flow path P3, and the connecting hole 614h, and may flow upward along an inner space of the hollow forming portion 652 through the air flow hole 652h. Accordingly, air may flow into the cooling chamber RC through the inlet 611.

Hereinafter, the flow of defrosted water or air in the drain cap 600 according to an embodiment of the present disclosure will be described with reference to FIGS. 31 to 33.

As illustrated in FIG. 31, when defrosted water is not drained, the water valve 630 may cover the valve hole 613a by being ascended by an attractive force between the fixed magnet 620 and the moving magnet 631, and the drain flow path may be closed. In addition, when the air pressure directing to the cooling chamber RC from the machine room RM is not sufficiently high, the air valve 650 may cover the connecting hole 614h by being descended by the self-weight, and the air flow path may be closed.

As illustrated in FIG. 32, when defrosted water is introduced into the drain cap 600 from the evaporator 50, the water valve 630 may be pushed down and descended by the defrosted water, and the drain flow path may be opened as the valve hole 613a is opened. The defrosted water passed through the valve hole 613a may be drained into the machine room RM through the outlet 612.

As illustrated in FIG. 33, when the air pressure directing to the cooling chamber RC from the machine room RM is high enough to ascend the air valve 650 (e.g., when the door 30 is opened), the air valve 650 may be pushed upward and ascended by the air pressure, and the air flow path may be opened as the connecting hole 614h is opened. Air in the machine room RM may be introduced into the third flow path P3 through the outlet 612, sequentially pass through the third flow path P3, the connecting hole 614h, and the air flow hole 652h, and then move to the cooling chamber RC side through the inlet 611.

Although the configuration and operation of the drain cap of the refrigerator according to various embodiments have been described above with reference to FIGS. 1 to 33 and the present disclosure has been described with the assumption that defrosted water flows vertically downward through the drain cap and that the water valve and the air valve is ascended or descended in the vertical direction, the present disclosure is not limited thereto. According to various embodiments of the present disclosure, defrosted water may flow in a direction of being inclined with respect to the vertical direction through the drain cap, and the water valve or the air valve may be ascended or descended in the direction of being inclined with respect to the vertical direction.

A refrigerator according to an embodiment of the present disclosure may include an evaporator, a drain pipe configured to guide defrosted water from the evaporator, and a drain cap configured to discharge defrosted water guided by the drain pipe. The drain cap may include a cap body configured to be connected with the drain pipe, having a drain flow path formed therein to drain defrosted water, and including a valve hole through which the drain flow path passes, a first magnet configured to be fixed to the cap body, and a water valve configured to be movable relative to the cap body and including a second magnet. The water valve may be configured to close the valve hole when ascended by a magnetic force between the first magnet and the second magnet. The water valve may be configured to open the valve hole when descended by defrosted water flowing along the drain flow path.

The second magnet may be disposed above the first magnet. The water valve may be configured to close the valve hole by being ascended by a repulsive force between the first magnet and the second magnet.

The water valve may be configured to be movable between an ascended position in which the valve hole is covered and a descended position spaced apart from the valve hole.

The water valve may be configured to be movable below the valve hole.

A width of the valve hole may be smaller than a width of the water valve.

The cap body may include an inlet provided to allow defrosted water from the drain pipe to be introduced and an outlet provided to allow defrosted water to be discharged. The valve hole may be disposed between the inlet and the outlet.

The drain cap may further include a magnet support configured to fix the first magnet to the cap body.

The magnet support may be configured to guide a movement of the water valve between a position in which the valve hole is closed and a position in which the valve hole is opened.

The refrigerator may further include a cooling chamber in which the evaporator is disposed, and a machine room in which a condenser and a compressor are disposed. The drain cap may be configured to drain defrosted water flowing along the drain flow path into the machine room. An air flow path may be formed inside the cap body such that air flows from the machine room toward the cooling chamber therethrough.

The cap body may include a partition configured to partition a portion of the drain flow path and a portion of the air flow path in a radial direction.

The portion of the drain flow path may be provided inside the partition. The portion of the air flow path may be provided outside the partition.

The drain cap may further include an air valve disposed inside the cap body and configured to be movable relative to the cap body. The air valve may be configured to close the air flow path in the descended position. The air valve may be configured to open the air flow path when ascended to the ascended position from the descended position.

The air valve may be configured to be located in the descended position by a self-weight of the air valve. The air valve may be configured to be ascended to the ascended position by an air pressure directing to the cooling chamber from the machine room.

The water valve may be disposed below the air valve.

The second magnet may be located below the first magnet. The water valve may be configured to close the valve hole by being ascended by an attractive force between the first magnet and the second magnet.

A refrigerator according to an embodiment of the present disclosure may include a cooling chamber in which an evaporator is disposed, a machine room in which a condenser and a compressor are disposed, and a drain cap configured to discharge defrosted water condensed inside the cooling chamber into the machine room. The drain cap may include a cap body having a drain flow path formed therein to drain defrosted water and including a valve hole through which the drain flow path passes, a first magnet configured to be fixed to the cap body, and a water valve configured to be movable relative to the cap body and including a second magnet. The water valve may be configured to limit drainage of defrosted water flowing along the drain flow path by closing the valve hole when ascended by a magnetic force between the first magnet and the second magnet. The water valve may be configured to allow defrosted water flowing along the drain flow path to be drained by opening the valve hole when descended by the defrosted water flowing along the drain flow path.

The second magnet may be disposed above the first magnet.

The water valve may be configured to close the valve hole by being ascended by a repulsive force between the first magnet and the second magnet.

The water valve may be configured to be movable in a vertical direction with respect to the first magnet.

A refrigerator according to an embodiment of the present disclosure may include an evaporator, a drain pipe configured to guide defrosted water from the evaporator, and a drain cap configured to be connected with the drain pipe and including a drain flow path provided to discharge defrosted water guided by the drain pipe. The drain cap may include a first magnet and a second magnet, and may include a water valve configured to be moveable between an ascended position, in which defrosted water is limited from being drained along the drain flow path by being ascended by a magnetic force between the first magnet and the second magnet, and a descended position, in which defrosted water is allowed to be drained along the drain flow path by being descended from the ascended position.

The drain cap may further include a movement guide configured to guide a movement of the water valve between the ascended position and the descended position.

According to the present disclosure, a drain cap of a refrigerator can open or close a drain flow path by including a water valve.

According to the present disclosure, when defrosted water is drained, the water valve can open the drain flow path by being descended by the defrosted water, and when defrosted water is not drained, the water valve can close the drain flow path by being ascended by a magnetic force between a moving magnet of the water valve and a fixed magnet.

According to the present disclosure, when defrosted water is not drained, the water valve can prevent air in a machine room from being introduced into the drain cap by closing the drain flow path.

According to the present disclosure, because the drain cap can be provided with an air valve configured to open an air flow path by a difference in air pressure between a cooling chamber and the machine room when a door is opened, air in the machine room can be introduced into a storage compartment through the drain cap, which facilitates the opening of the door.

Effects according to the present disclosure are not limited to the effects mentioned above, and other effects not mentioned will be clearly understood by those skilled in the art to which the present disclosure belongs from the fallowing description.

The foregoing has illustrated and described specific embodiments. However, it should be understood by those of skilled in the art that the present disclosure is not limited to the above-described embodiments, and various changes and modifications may be made without departing from the technical idea of the present disclosure described in the following claims.

1. A refrigerator comprising:
an evaporator;
a drain pipe configured to guide water from a surface of the evaporator; and
a drain cap configured to discharge the water guided by the drain pipe, the drain cap including:
a cap body connectable to the drain pipe, the cap body having formed therein a drain flow path along which the water is flowable, and including:
a valve hole through which the drain flow path passes,
a first magnet configured to be fixed to the cap body, and
a water valve movable relative to the cap body to open and close the valve hole, and including a second magnet,
wherein the drain cap is configured so that, with the cap body connected to the drain pipe, the water valve is movable between:
a closed position where the water valve is moved by a magnetic force between the first magnet and the second magnet to close the valve hole so that the water is blocked from passing through the valve hole by the water valve, and
an open position where the water valve is moved away from the valve hole by the water overcoming the magnetic force between the first magnet and the second magnet to open the valve hole so that a flow of the water passes through the valve hole and is discharged from the drain cap.

2. The refrigerator according to claim 1, wherein
the second magnet is above the first magnet, and
the water valve is configured to move to the closed position by being ascended by a repulsive force between the first magnet and the second magnet.

3. The refrigerator according to claim 1, wherein the water valve is configured to be movable between an ascended position in which the water valve is in the closed position and a descended position in which the water valve is in the open position and is spaced apart from the valve hole.

4. The refrigerator according to claim 1, wherein the water valve is movable below the valve hole.

5. The refrigerator according to claim 1, wherein a width of the valve hole is smaller than a width of the water valve.

6. The refrigerator according to claim 1, wherein
the cap body includes:
an inlet configured to allow the water from the drain pipe to be introduced into the cap body, and
an outlet configured to allow the water, introduced into the cap body by the inlet, to be discharged from the cap body, and
the valve hole is between the inlet and the outlet.

7. The refrigerator according to claim 1, wherein the drain cap further includes a magnet support configured to fix the first magnet to the cap body.

8. The refrigerator according to claim 7, wherein the magnet support is configured to guide a movement of the water valve between the closed position and the open position.

9. The refrigerator according to claim 1, further comprising:
a cooling chamber; and
a machine room, wherein
the evaporator is in the cooling chamber,
a condenser and a compressor are in the machine room,
the drain cap is configured so that, with the cap body connected to the drain pipe, the water is flowable along the drain flow path into the machine room, and
an air flow path is formed inside the cap body and configured so that, with the cap body connected to the drain pipe, air is flowable from the machine room toward the cooling chamber along the air flow path.

10. The refrigerator according to claim 9, wherein
the cap body includes a partition that partitions, in a radial direction of the cap body, a portion of the drain flow path from a portion of the air flow path.

11. The refrigerator according to claim 10, wherein
the portion of the drain flow path is inside the partition, and
the portion of the air flow path is outside the partition.

12. The refrigerator according to claim 9, wherein
the drain cap further includes an air valve inside the cap body, and
the drain cap is configured so that, with the cap body connected to the drain pipe, the air valve is movable relative to the cap body to:
close the air flow path, and
open the air flow path.

13. The refrigerator according to claim 12, wherein
the air valve is configured to:
move to a descended position to close the air flow path by a self-weight of the air valve, and
move to an ascended position to open the air flow path by an air pressure difference between the cooling chamber and the machine room.

14. The refrigerator according to claim 12, wherein the water valve is below the air valve.

15. The refrigerator according to claim 1, wherein
the second magnet is located below the first magnet, and
the water valve is configured to close the valve hole by the water valve being ascended by an attractive force between the first magnet and the second magnet.
